(19) United States
(12) Patent Application Publication
(10) Pub. No.: US 2024/0380437 A1
(43) Pub. Date: Nov. 14, 2024

(54) RECONFIGURABLE INTELLIGENT SURFACE OPERATIONS WITH AN UNKNOWN TRANSMISSION DISTANCE

(71) Applicant: QUALCOMM Incorporated, San Diego, CA (US)

(72) Inventors: Yavuz YAPICI, Florham Park, NJ (US); Narayan PRASAD, Westfield, NJ (US); Tao LUO, San Diego, CA (US); Junyi LI, Fairless Hills, PA (US)

(21) Appl. No.: 18/315,274

(22) Filed: May 10, 2023

(51) Int. Cl. H04B 7/04

(52) U.S. Cl. CPC H04B 7/04013

(57) ABSTRACT

Methods, systems, and devices for wireless communication are described. A reconfigurable reflective surface (RIS) may receive control information from a network entity. The control information may be usable at the RIS for determination of a set of phase parameters. The RIS may determine whether distance information between the network entity and the RIS is available. The RIS may determine the set of phase parameters in accordance with the control information. The set of phase parameters may be usable by the RIS for reflecting communications from the network entity to a user equipment (UE) in accordance with a focusing distance that may be based on the determined availability of the distance information. The RIS may apply the set of phase parameters to reflect a signal from the network entity to the UE.

### FIELD OF TECHNOLOGY

The following relates to wireless communication, including reconfigurable intelligent surface (RIS) operations with an unknown transmission distance.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some cases, a network entity may communicate with a UE via a reconfigurable intelligent surface (RIS) to extend a wireless coverage area. In some cases, existing techniques for communication via a RIS may be deficient.

### SUMMARY

The described techniques relate to improved methods, systems, devices, and apparatuses that support reconfigurable intelligent surface (RIS) operations with an unknown transmission distance. For example, the described techniques provide a framework for RIS beamfocusing operations with an unknown transmission distance. In some examples, the RIS may receive control information from the network entity. The control information may be usable at the RIS for determination of a set of phase parameters. The RIS may determine whether distance information between the network entity and the RIS is available. Additionally, the RIS may determine the set of phase parameters in accordance with the control information. The set of phase parameters may be usable by the RIS for reflecting communications from the network entity to a user equipment (UE). For example, the set of phase parameters may be usable by the RIS for reflecting communications from the network entity to the UE in accordance with a focusing distance that may be based on the determined availability of the distance information. In some examples, the RIS may apply the set of phase parameters to reflect a signal from the network entity to the UE.

A method for wireless communications at a RIS is described. The method may include receiving, from a network entity, control information for determination of a set of phase parameters at the RIS, determining whether distance information between the network entity and the RIS is available, determining the set of phase parameters for the RIS in accordance with the control information, the set of phase parameters is usable by the RIS for reflecting communications from the network entity to a UE in accordance with a focusing distance that is based on the determined availability of the distance information, and applying the set of phase parameters to reflect a signal from the network entity to the UE via the RIS.

An apparatus for wireless communications at a RIS is described. The apparatus may include at least one processor, and at least one memory coupled with the at least one processor, where the at least one memory includes instructions. The instructions may be executable by the at least one processor to cause the apparatus to receive, from a network entity, control information for determination of a set of phase parameters at the RIS, determine whether distance information between the network entity and the RIS is available, determine the set of phase parameters for the RIS in accordance with the control information, the set of phase parameters is usable by the RIS for reflecting communications from the network entity to a UE in accordance with a focusing distance that is based on the determined availability of the distance information, and apply the set of phase parameters to reflect a signal from the network entity to the UE via the RIS.

Another apparatus for wireless communications at a RIS is described. The apparatus may include means for receiving, from a network entity, control information for determination of a set of phase parameters at the RIS, means for determining whether distance information between the network entity and the RIS is available, means for determining the set of phase parameters for the RIS in accordance with the control information, the set of phase parameters is usable by the RIS for reflecting communications from the network entity to a UE in accordance with a focusing distance that is based on the determined availability of the distance information, and means for applying the set of phase parameters to reflect a signal from the network entity to the UE via the RIS.

A non-transitory computer-readable medium storing code for wireless communications at a RIS is described. The code may include instructions executable by at least one processor to receive, from a network entity, control information for determination of a set of phase parameters at the RIS, determine whether distance information between the network entity and the RIS is available, determine the set of phase parameters for the RIS in accordance with the control information, the set of phase parameters is usable by the RIS for reflecting communications from the network entity to a UE in accordance with a focusing distance that is based on the determined availability of the distance information, and apply the set of phase parameters to reflect a signal from the network entity to the UE via the RIS.

In some examples of the method, apparatuses, and non-transitory computer-readable medium described herein, receiving the control information may include operations, features, means, or instructions for receiving an indication of the set of phase parameters.

In some examples of the method, apparatuses, and non-transitory computer-readable medium described herein, receiving the control information may include operations, features, means, or instructions for receiving an indication of an angular direction for determining of the set of phase parameters.

Some examples of the method, apparatuses, and non-transitory computer-readable medium described herein may further include operations, features, means, or instructions for receiving an indication of the distance information, where determining the set of phase parameters may be based on the distance information.

In some examples of the method, apparatuses, and non-transitory computer-readable medium described herein, receiving the control information may include operations, features, means, or instructions for receiving downlink control information (DCI) or a radio resource control (RRC) message including the control information.

Some examples of the method, apparatuses, and non-transitory computer-readable medium described herein may further include operations, features, means, or instructions for determining that the distance information may be available, where the focusing distance may be based on the available distance information, and where the set of phase parameters may be based on a first link between the RIS and the UE being served via beamfocusing in accordance with the focusing distance.

Some examples of the method, apparatuses, and non-transitory computer-readable medium described herein may further include operations, features, means, or instructions for determining a distance between the network entity and the RIS based on the available distance information, where the focusing distance may be based on whether the distance satisfies a distance threshold.

Some examples of the method, apparatuses, and non-transitory computer-readable medium described herein may further include operations, features, means, or instructions for determining whether an accuracy of the available distance information satisfies an accuracy threshold, where the set of phase parameters may be based on whether the accuracy satisfies the accuracy threshold.

Some examples of the method, apparatuses, and non-transitory computer-readable medium described herein may further include operations, features, means, or instructions for determining that the accuracy of the available distance information satisfies the accuracy threshold, where the set of phase parameters may be based on a second link between the network entity and the RIS being served via beamfocusing in accordance with the available distance information.

Some examples of the method, apparatuses, and non-transitory computer-readable medium described herein may further include operations, features, means, or instructions for determining that the accuracy of the available distance information fails to satisfy the accuracy threshold, where the set of phase parameters may be based on a second link between the network entity and the RIS being served via beamforming.

Some examples of the method, apparatuses, and non-transitory computer-readable medium described herein may further include operations, features, means, or instructions for determining a distance between the network entity and the RIS based on the available distance information, where the accuracy threshold may be based on the determined distance.

Some examples of the method, apparatuses, and non-transitory computer-readable medium described herein may further include operations, features, means, or instructions for determining that the distance information may be unavailable, where the focusing distance may be based on the distance information being unavailable, and where the set of phase parameters may be based on a first link between the RIS and the UE being served via beamfocusing in accordance with the focusing distance and a second link between the network entity and the RIS being served via beamforming.

In some examples of the method, apparatuses, and non-transitory computer-readable medium described herein, the focusing distance may be based on one or more parameters associated with the RIS, one or more parameters associated with the communications from the network entity, or a geometry of an incident and reflected angle pair, or any combination thereof.

A method for wireless communications at a network entity is described. The method may include detecting a presence of a RIS for communicating with a UE, determining whether distance information between the network entity and the RIS is available, outputting control information associated with a set of phase parameters for the RIS, the set of phase parameters is usable by the RIS for reflecting communications from the network entity to the UE in accordance with a focusing distance that is based on the determined availability of the distance information, and communicating a signal with the UE via the RIS in accordance with the set of phase parameters.

An apparatus for wireless communications at a network entity is described. The apparatus may include at least one processor, and at least one memory coupled with the at least one processor, where the at least one memory includes instructions. The instructions may be executable by the at least one processor to cause the apparatus to detect a presence of a RIS for communicating with a UE, determine whether distance information between the network entity and the RIS is available, outputting control information associate with a set of phase parameters for the RIS, the set of phase parameters is usable by the RIS for reflecting communications from the network entity to the UE in accordance with a focusing distance that is based on the determined availability of the distance information, and communicate a signal with the UE via the RIS in accordance with the set of phase parameters.

Another apparatus for wireless communications at a network entity is described. The apparatus may include means for detecting a presence of a RIS for communicating with a UE, means for determining whether distance information between the network entity and the RIS is available, means for outputting control information associated with a set of phase parameters for the RIS, the set of phase parameters is usable by the RIS for reflecting communications from the network entity to the UE in accordance with a focusing distance that is based on the determined availability of the distance information, and means for communicating a signal with the UE via the RIS in accordance with the set of phase parameters.

A non-transitory computer-readable medium storing code for wireless communications at a network entity is described. The code may include instructions executable by at least one processor to detect a presence of a RIS for communicating with a UE, determine whether distance information between the network entity and the RIS is available, outputting control information associate with a set of phase parameters for the RIS, the set of phase parameters is usable by the RIS for reflecting communications from the network entity to the UE in accordance with a focusing distance that is based on the determined availability of the distance information, and communicate a signal with the UE via the RIS in accordance with the set of phase parameters.

Some examples of the method, apparatuses, and non-transitory computer-readable medium described herein may further include operations, features, means, or instructions for determining the set of phase parameters for the RIS based on the determined availability of the distance information.

In some examples of the method, apparatuses, and non-transitory computer-readable medium described herein, outputting the control information may include operations, features, means, or instructions for outputting an indication of the determined set of phase parameters.

In some examples of the method, apparatuses, and non-transitory computer-readable medium described herein, outputting the control information may include operations, features, means, or instructions for outputting a first indication of an angular direction for determination of the set of phase parameters.

Some examples of the method, apparatuses, and non-transitory computer-readable medium described herein may further include operations, features, means, or instructions for determining that the distance information may be available and outputting a second indication of the available distance information for the determination of the set of phase parameters.

In some examples of the method, apparatuses, and non-transitory computer-readable medium described herein, outputting the control information may include operations, features, means, or instructions for outputting DCI or an RRC message including the control information.

Some examples of the method, apparatuses, and non-transitory computer-readable medium described herein may further include operations, features, means, or instructions for determining that the distance information may be available, where the focusing distance may be based on the available distance information, and where the set of phase parameters may be based on a first link between the RIS and the UE being served via beamfocusing in accordance with the focusing distance.

Some examples of the method, apparatuses, and non-transitory computer-readable medium described herein may further include operations, features, means, or instructions for determining a distance between the network entity and the RIS based on the available distance information, where the focusing distance may be based on whether the distance satisfies a distance threshold.

Some examples of the method, apparatuses, and non-transitory computer-readable medium described herein may further include operations, features, means, or instructions for determining whether an accuracy of the available distance information satisfies an accuracy threshold, where the set of phase parameters may be based on whether the accuracy satisfies the accuracy threshold.

Some examples of the method, apparatuses, and non-transitory computer-readable medium described herein may further include operations, features, means, or instructions for determining that the accuracy of the available distance information satisfies the accuracy threshold, where the set of phase parameters may be based on a second link between the network entity and the RIS being served via beamfocusing in accordance with the available distance information.

Some examples of the method, apparatuses, and non-transitory computer-readable medium described herein may further include operations, features, means, or instructions for determining that the accuracy of the available distance information fails to satisfy the accuracy threshold, where the set of phase parameters may be based on a second link between the network entity and the RIS being served via beamforming.

Some examples of the method, apparatuses, and non-transitory computer-readable medium described herein may further include operations, features, means, or instructions for determining a distance between the network entity and the RIS based on the available distance information, where the accuracy threshold may be based on the determined distance.

Some examples of the method, apparatuses, and non-transitory computer-readable medium described herein may further include operations, features, means, or instructions for determining that the distance information may be unavailable, where the focusing distance may be based on the distance information being unavailable, and where the set of phase parameters may be based on a first link between the RIS and the UE being served via beamfocusing in accordance with the focusing distance and a second link between the network entity and the RIS being served via beamforming.

In some examples of the method, apparatuses, and non-transitory computer-readable medium described herein, the focusing distance may be based on one or more parameters associated with the RIS, one or more parameters associated with the communications from the network entity, or a geometry of an incident and reflected angle pair, or any combination thereof.

### BRIEF DESCRIPTION OF THE DRAWINGS

FIGS. 1 through 3 each show an example of a wireless communications system that supports reconfigurable intelligent surface (RIS) operations with an unknown transmission distance in accordance with one or more aspects of the present disclosure.

FIGS. 4 and 5 shows an example of a process flow that supports RIS operations with an unknown transmission distance in accordance with one or more aspects of the present disclosure.

FIGS. 6 and 7 show block diagrams of devices that support RIS operations with an unknown transmission distance in accordance with one or more aspects of the present disclosure.

FIG. 8 shows a block diagram of a communications manager that supports RIS operations with an unknown transmission distance in accordance with one or more aspects of the present disclosure.

FIG. 9 shows a diagram of a system including a device that supports RIS operations with an unknown transmission distance in accordance with one or more aspects of the present disclosure.

FIGS. 10 and 11 show block diagrams of devices that support RIS operations with an unknown transmission distance in accordance with one or more aspects of the present disclosure.

FIG. 12 shows a block diagram of a communications manager that supports RIS operations with an unknown transmission distance in accordance with one or more aspects of the present disclosure.

FIG. 13 shows a diagram of a system including a device that supports RIS operations with an unknown transmission distance in accordance with one or more aspects of the present disclosure.

FIGS. 14 and 15 show flowcharts illustrating methods that support RIS operations with an unknown transmission distance in accordance with one or more aspects of the present disclosure.

### DETAILED DESCRIPTION

Wireless communications systems may be configured to support multiple-input, multiple-output (MIMO) communications at various frequency bands to enable increased throughput within the wireless communications systems. The devices (e.g., user equipments (UEs) and network entities) of the wireless communications system may support beamforming in order to improve signal reliability and efficiency for MIMO communications. In some cases, a beamformed link between a UE and a network entity may be impacted by external factors, such as a physical blocking object, signal fading, or other phenomena. To support communications in the presence of such external factors, the wireless communications system may use additional wireless nodes that may be configured to route communications such that the external factors are limited or avoided.

In some examples, wireless nodes may be active, passive, or mostly passive (e.g., near passive) devices. Example active devices may include active antenna units (AAUs) or wireless repeaters, and such devices may include active antennas and supporting radio frequency circuitry. Active devices may receive a signal from a transmitting device (e.g., a UE or a network entity) and actively retransmit the signal to a receiving device (e.g., a UE or a network entity). However, given the active nature of such devices, AAUs and wireless repeaters may lead to increased power consumption. Example passive (or nearly passive) devices may include reconfigurable reflective surfaces, which may also be referred to as reconfigurable intelligent surfaces (RISs), channel engineering devices (CEDs), or configurable deflectors. Although a RIS is referred to throughout the disclosure, it should be understood that the techniques described herein may also apply to other reconfigurable reflective surfaces. A RIS may act as a near passive device (though it might have active transmitting elements, such as a power amplifier) that reflects an impinging wave into a desired direction. For example, a RIS may include a set of elements which may be used to receive a signal from a transmitting device (e.g., a UE or network entity) and reflect the signal towards a receiving device (e.g., another UE or network entity) according to a configuration. In other words, a RIS may use configured phase information (e.g., for each element of the set of elements), which may be referred to as a configuration or a phase matrix, to reflect impinging waves in a desired direction. Near passive devices may consume less power than active devices and, as such, a wireless communications system may employ one or more RISs to extend communications coverage around (or because of) blockages with negligible power consumption and deployment costs.

In some cases, the direction in which a RIS reflects an impinging wave may be based on a configuration (e.g., a reflective phase configuration) of the RIS. For example, the configuration may include phase information for one or more elements included in the RIS. The RIS may then use the configuration to reflect signals transmitted from the network entity towards a target UE and, similarly, reflect signals transmitted from the target UE towards the network entity. In some examples, the configuration may be based on a beam formation method used to serve a first link between the network entity and the RIS and a second link between the RIS and the target UE. For example, the configuration may be based on whether the first link and the second link may be served via beamforming or beamfocusing, or both. Beamforming may be carried out by using the direction information (e.g., only direction information) of the target receiver, while beamfocusing may include use of the direction information and distance information, such as between a transmitter (e.g., the network entity) and a target receiver (e.g., the target UE). For example, the direction information may include an angle between the network entity and the RIS for the first link, or an angle between the RIS and the target UE for the second link, or both. Additionally, the distance information may include a distance between the network entity and the RIS for the first link, or a distance between the RIS and the target UE for the second link, or both. In some examples, the network entity and the RIS may serve the first link and the second link via beamforming. In such examples, the configuration may be based on angle information, such as an angle of the incident beam from the network entity or an angle associated with the direction of the target UE, or both. In other words, the RIS may form the reflected beam based on angle information. In some examples, a received power attainable by beamforming may be relatively low.

In some examples, the first link and the second link may experience near-field effects. A quality of communication over a link experiencing near-field effects may be improved using beamfocusing. As such, the network entity and the RIS may serve the first link or the second link, or both, via beamfocusing, for example, to increase a received power at the target UE. In some examples, to achieve beamfocusing for the first link or the second link, the configuration of the RIS may depend on both angle information and distance information. For example, to achieve beamfocusing for the first link, the configuration may be based on angle information and a distance between the network entity and the RIS. Similarly, to achieve beamfocusing for the second link, the configuration may be based on angle information and a distance between the RIS and the UE. In some examples, the distance between the RIS and the UE may be unavailable (e.g., unknown to one or both of the RIS and the network entity). In such examples, the RIS may use a selected (e.g., static, fixed, preconfigured) focusing distance that may be based on the distance between the network entity and the RIS. In some examples, however, the RIS may be mobile and the distance between the network entity and the RIS may be unknown or imprecise (e.g., relatively inaccurate).

Various aspects of the present disclosure relate to techniques for RIS operations with an unknown transmission distance and, more specifically, to a framework for RIS beamfocusing operations with an unknown transmission distance. For example, the RIS may receive control information from a network entity. The RIS may use the control information for determination of the configuration. For example, in accordance with the control information, the RIS may determine the configuration based on whether distance information between the network entity and the RIS is available. The configuration may be usable by the RIS for reflecting communications from the network entity to a target UE in accordance with a focusing distance that may be based on the determined availability of the distance information.

In some examples, the distance information between the network entity and the RIS may be unavailable. In such examples, the RIS may determine the configuration based on a first link between the network entity and the RIS being served via beamforming and a second link between the RIS and the target UE being served via beamfocusing in accordance with a selected focusing distance (e.g., a preselected or preconfigured focusing distance). In some other examples, the distance information between the network entity and the RIS may be available. In such examples, the RIS may determine the configuration based on the first link being served via beamforming or beamfocusing (e.g., in accordance with the available distance information) and the second link being served via beamfocusing in accordance with another selected focusing distance (e.g., another preselected or preconfigured focusing distance).

Aspects of the subject matter described herein may be implemented to realize one or more of the following potential advantages. For example, the techniques employed by the described communication devices may provide benefits and enhancements to the operation of the communication devices, including enabling beamfocusing for unknown transmission distances. The operations performed by the described communication devices to enable beamfocusing may include selection of a focusing distance based on an availability of distance information. In some examples, operations performed by the described communication devices may also support increased reliability of communications within a wireless communications system, among other benefits. Aspects of the disclosure are initially described in the context of wireless communications systems and process flows. Aspects of the disclosure are further illustrated by and described with reference to apparatus diagrams, system diagrams, and flowcharts that relate to RIS operations with an unknown transmission distance.

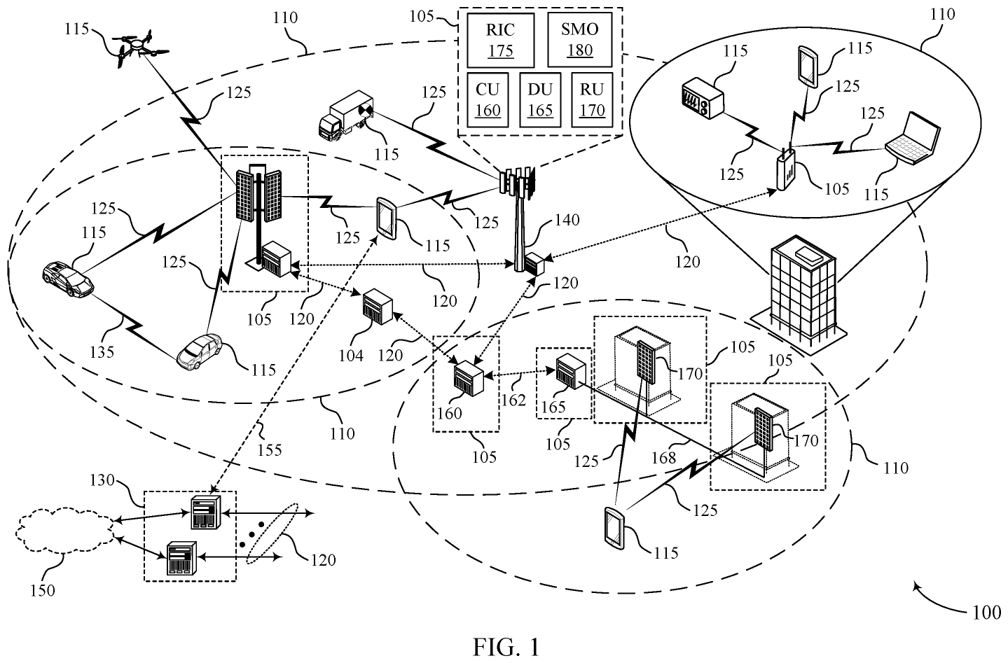

FIG. 1 shows an example of a wireless communications system 100 that supports RIS operations with an unknown transmission distance in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support RIS operations with an unknown transmission distance as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may employ near passive devices, such as one or more RISs, to extend communications coverage around (or because of) blockages with negligible power consumption costs. In some cases, a direction in which a RIS reflects an impinging wave may be based on a configuration (e.g., a reflective phase configuration) of the RIS. The configuration may be based on a beam formation method used to serve a first link between a transmitting device (e.g., a network entity 105) and the RIS and a second link between the RIS and a receiving device (e.g., a target UE, a UE 115). For example, the configuration may be based on whether the first link and the second link may be served via beamforming or beamfocusing, or both. In some examples, the first link and the second link may experience near-field effects and a quality of communication over a link experiencing near-field effects may be improved using beamfocusing. As such, the network entity 105 and the RIS may serve the first link or the second link, or both, via beamfocusing to increase a received power at the UE 115. In some examples, to achieve beamfocusing for the first link, the configuration may be based on angle information and a distance between the network entity 105 and the RIS. Similarly, to achieve beamfocusing for the second link, the configuration may be based on angle information and a distance between the RIS and the UE 115. In some examples, however, the distance between the network entity 105 and the RIS or the distance between the RIS and the UE 115, or both, may be unavailable (e.g., unknown to one or both of the RIS and the network entity 105).

In some examples, the RIS and the network entity 105 may support a framework for RIS beamfocusing operations with an unknown transmission distance. For example, the RIS may receive control information from a network entity 105. The RIS may use the control information for determination of the configuration. For example, in accordance with the control information, the RIS may determine the configuration based on whether distance information between the network entity 105 and the RIS is available. The configuration may be usable by the RIS for reflecting communications from the network entity 105 to a UE 115 in accordance with a focusing distance that may be based on the determined availability of the distance information.

In some examples, the distance information between the network entity 105 and the RIS may be unavailable. In such examples, the RIS may determine the configuration based on a first link between the network entity 105 and the RIS being served via beamforming and a second link between the RIS and the UE 115 being served via beamfocusing in accordance with a selected focusing distance (e.g., a preselected or preconfigured focusing distance). In some other examples, the distance information between the network entity 105 and the RIS may be available. In such examples, the RIS may determine the configuration based on the first link being served via beamforming or beamfocusing (e.g., in accordance with the available distance information) and the second link being served via beamfocusing in accordance with another selected focusing distance (e.g., another preselected or preconfigured focusing distance). In some examples, enabling beamfocusing for unknown transmission distances may lead to increased reliability of communications within the wireless communications system 100, among other benefits.

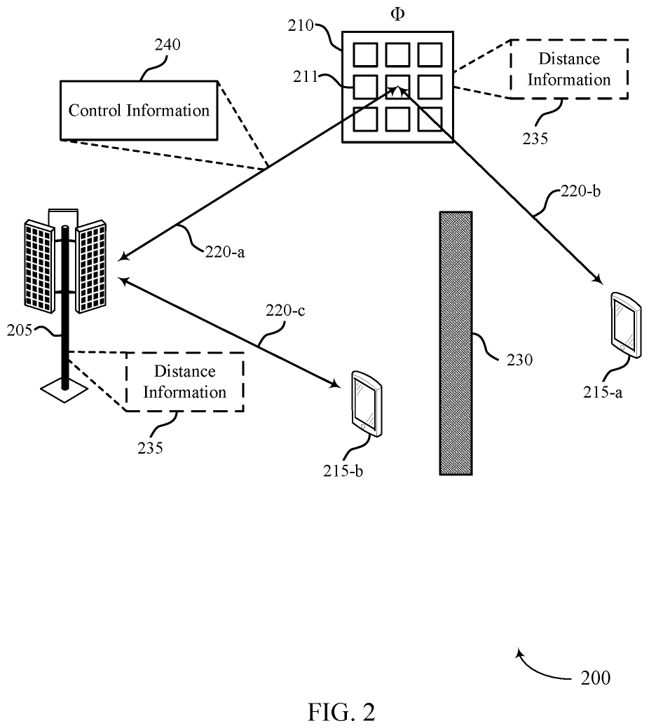

FIG. 2 shows an example of a wireless communications system 200 that supports RIS operations with an unknown transmission distance in accordance with one or more aspects of the present disclosure. In some examples, the wireless communications system 200 may implement aspects of wireless communications system 100. For instance, the wireless communications system 200 may include a network entity 205, a UE 215-a, and a UE 215-b, which may be examples of the corresponding devices described with reference to FIG. 1. The wireless communications system 200 may include features for improved communications between the UEs 215 and the network entity 205, among other benefits.

The wireless communications system 200 illustrates communications between the network entity 205 and a UE 215-a in the presence of a blocker 230. The wireless communications system 200 also illustrates communications between the network entity 205 and a UE 215-b in the absence of the blocker 230. In the absence of the blocker 230, a network entity 205 may directly transmit signals to the UE 215-b via a link 220-c. However, because a direct path between the UE 215-a and the network entity 205 is obstructed by the blocker 230, the network entity 205 may be unable to directly transmit signals to the UE 215-a. The blocker 230 may represent a physical obstruction, signal fading, or any other phenomenon or combination of phenomena that may cause communications between the network entity 205 and the UE 215-a to experience signal loss or interference. In the example of FIG. 2, the blocker 230 may be a physical obstruction (e.g., buildings, mountains, people) positioned such that direct communications between the UE 215-a and the network entity 205 may be impacted, such as by experiencing signal loss or interference. Signal loss or interference may be determined at the network entity 205, the UE 215-a, or both. Additionally, it should be understood that the implementations described herein may be applicable with or without the blocker 230.

In some cases, to correct signal loss or to otherwise improve the spectral efficiency or reliability of a wireless connection between the network entity 205 and the UE 215-a, the network entity 205 may utilize one or more wireless nodes (e.g., additional wireless nodes). That is, the network entity may use one or more wireless nodes, to extend coverage and enhance communications with the UE 215-a. For example, the network entity 205 may extend coverage and enhance communications with the UE 215-a through the use of active devices or near passive devices. In some examples, the network entity 205 may use active or near passive devices to achieve relatively high beamforming gain. For example, the network entity 205 may employ active or near passive devices for both uplink and downlink communications with the UE 215-a to circumvent the blocker 230 or for other communication enhancement purposes. An active device, such as an AAU, may include individual radio frequency chains per antenna port and, as such, may be associated with increased power consumption. Passive or near passive device, such as the RIS 210, may be deployed in a wireless network (e.g., the wireless communications system 200) to extend coverage with reduced (e.g., negligible) power consumption. For example, a surface of the RIS 210 may include a set of elements (e.g., passive and reconfigurable reflective elements, such as a reflective element 211), which the RIS 210 may use to receive a signal from the network entity 205 via a link 220-a and reflect the signal towards the UE 215-a via a link 220-b. In some examples, a direction at which signals may be reflected off of the RIS 210 may be based on a phase associated with (e.g., configured for) the set of elements. For example, the RIS 210 (or another device which may serve to control the RIS 210) may modify (e.g., change, adjust) a phase introduced to one or more (e.g., each) elements on the surface of the RIS 210 to modify the direction at which an incident (e.g., incoming) signal may be reflected off of the surface of the RIS 210. In other words, the RIS 210 may include a set of elements which the network entity 205 may leverage to steer signals transmitted from the network entity 205 towards the UE 215-a. In some examples, a respective phase introduced to each element of the surface of the RIS 210 may be based on a configuration (e.g., a set of phase parameters, a phase matrix). In some examples, the configuration may be referred to as phi or Φ.

For example, the RIS 210 may include a set of M elements (e.g., reconfigurable reflective elements, components) and each element of the RIS 210 may be configured to redirect (e.g., reflect, refract, or diffract) communications between the network entity 205 and the UE 215-a. A direction of a reflected signal (e.g., beam) may be controllable by the network entity 205 or the RIS 210. For example, the network entity 205 may indicate a configuration (e.g., Φ) to the RIS 210 or the RIS 210 may otherwise determine the configuration. For example, the RIS 210 may include a RIS controller capable of determining a configuration (e.g., reflection coefficients, the set of phase parameters) to adjust an angle of the reflected signal (e.g., without decoding the signal). In some examples, the configuration determined at the RIS 210 (e.g., via the RIS controller) may be based on information provided by the network entity 205. For example, the RIS controller may include one or more communication components (e.g., a transmission processor, a reception processor, a controller processor) to receive control signaling, for example, from the network entity 205.

In some cases, the configuration (Φ) may be a reflection configuration matrix (e.g., a phase matrix) which may define a phase for reflective elements (e.g., the reflective element 211) at the RIS 210. For example, the configuration may be an example of a diagonalized matrix. In such an example, the configuration may include a quantity of elements in which off diagonal elements may have a value of 0 and diagonal elements may define a respective phase (e.g., relative phase) for each element involved in the reflection process (e.g., the elements involved in reflecting signals from the network entity 205 to the UE 215-a and, similarly, from the UE 215-a to the network entity 205). In some cases, a quantity of elements involved in the reflecting process (e.g., a quantity of elements along the diagonal of phase matrix) may be less than or equal to M.

In some examples, the network entity 205 and the RIS 210 may use one or more methods to serve RIS-assisted links (the link 220-a between the network entity 205 and the RIS 210 and the link 220-b between the RIS 210 and the UE 215-a). For example, the RIS-assisted links may be served by beamforming or beamfocusing. As described herein, a RIS-assisted link between a transmitting device and a RIS may be referred to as a Tx-to-RIS link and a RIS-assisted link between the RIS and a receiving device may be referred to as a RIS-to-Rx link. That is, the link 220-a may be an example of a Tx-to-RIS link and the link 220-b may be an example of a RIS-to-Rx link. In some examples, the network entity 205 and the RIS 210 may serve the link 220-a and the link 220-b via beamforming. For example, the network entity 205 may perform a beamforming operation in which the network entity 205 may steer a beam towards the RIS 210 (e.g., in a direction of the RIS 210) and the RIS 210 may perform a beamforming operation in which the RIS 210 may steer the beam towards the UE 215-a (e.g., in a direction of the UE 215-a). In such an example, the configuration (Φ) of the RIS 210 may depend on angle information (e.g., an angle of the incident beam from the network entity 205, an angle associated with the direction of the UE 215-a). In other words, the RIS 210 may shape the reflected beam based on angle information. In some examples, a received power attainable by beamforming may be relatively low.

To increase a received power at the UE 215-a, the network entity 205 or the RIS 210 may use beamfocusing. That is, the network entity 205 or the RIS 210 may perform a beamfocusing operation to increase a received power at the UE 215-a. For example, the RIS-assisted links (the link 220-a and the link 220-b) may experience a near-field effect (e.g., due to an effective aperture size of the RIS 210 being large relatively a transmit array). In some examples, link quality of near-field communication over RIS-assisted links may be improved using beamfocusing in which a beam may be shaped based on angle and distance information. As such, serving the link 220-a or the link 220-b (or both) with beamfocusing may lead to increased received power at the UE 215-a. For example, the network entity 205 may perform a beamfocusing operation in which the network entity 205 may both steer and focus a beam towards the RIS 210. In other words, the network entity 205 may serve the link 220-a via beamfocusing. In some examples, the network entity 205 may focus the beam using a focusing distance that may be based on a location of the RIS 210. Additionally, or alternatively, the RIS 210 may perform a beamforming operation in which the RIS 210 may both steer and focus the beam towards the UE 215-a. That is, the RIS 210 (e.g., the network entity 205 via the RIS 210) may serve the link 220-b via beamfocusing. In some examples, the RIS 210 may focus the beam using a focusing distance that may be based on a location of the UE 215-a) In some examples, to achieve beamfocusing for one or more RIS-assisted links, the configuration (Φ) of the RIS 210 may depend on both angle information and distance information (e.g., a distance between the network entity 205 and the RIS 210, a distance between the RIS 210 and the UE 215-a). In other words, the RIS 210 may perform the beamfocusing operation (e.g., may use beamfocusing, may apply beamfocusing) in accordance with a focusing distance, which may be adjusted (e.g., tuned, changed, modified) based on the distance between the network entity 205 and the RIS 210 or the distance between the RIS 210 and the UE 215-a (or both) to increase the received power at the UE 215-a.

In some examples, the distance between the RIS 210 and the UE 215-a may be unavailable (e.g., unknown to one or both of the RIS 210 and the network entity 205). In such examples, the RIS 210 may use a selected (e.g., static, fixed, preconfigured) focusing distance that may be based on the distance between the network entity 205 and the RIS 210. That is, if a first distance between the network entity 205 and the RIS 210 is known and a second distance between the RIS 210 and the UE 215-a is unknown, the configuration (Φ) of the RIS 210 may be determined such that the link 220-a may be served using beamfocusing in accordance with the known first distance and the link 220-b may be served using beamfocusing in accordance with the selected focusing distance that depends on the first distance. In some examples, however, the RIS 210 may be mobile and the first distance between the network entity 205 and the RIS 210 may be unknown or imprecise (e.g., relatively inaccurate).

In some examples, one or more techniques for RIS operations with an unknown transmission distance, as described herein, may provide a framework for RIS beamfocusing operations with an unknown distance between the network entity 205 and the RIS 210. For example, such techniques may enable the network entity 205 or the RIS 210 to determine a set of phase parameters (e.g., the configuration (Φ) for the RIS 210, the phase matrix) based on a focusing distance that depends on whether distance information 235 between the network entity 205 and the RIS 210 is available. For example, the RIS 210 may receive control information 240 from the network entity 205 via the link 220-a. The RIS 210 may use the control information 240 for determining the configuration. That is, RIS 210 may use the control information 240 for determining the set of phase parameters for the RIS 210. The RIS 210 may determine whether distance information 235 is available. Additionally, in some examples, the RIS 210 may determine the configuration for the RIS 210 in accordance with the control information 240. In such examples, the configuration (e.g., the set of phase parameters) may be usable by the RIS 210 for reflecting communications from the network entity 205 to the UE 215-a in accordance with a focusing distance that is based on the determined availability of the distance information 235.

In some examples, the distance information 235 between the network entity 205 and the RIS 210 may be unavailable. In such examples, the network entity 205 or the RIS 210 may determine the configuration based on the link 220-a being served via beamforming and the link 220-b being served via beamfocusing in accordance with a selected (e.g., preselected, preconfigured, predefined) focusing distance. In some other examples, the distance information 235 between the network entity 205 and the RIS 210 may be available. In such examples, the network entity 205 or the RIS 210 may determine the configuration based on the link 220-a being served via beamforming or beamfocusing and the link 220-b being served via beamfocusing.

In some examples, such as example in which the distance information 235 may be available, the focusing distance for the link 220-b may be based on whether a distance indicated via the distance information 235 satisfies a threshold distance. In some examples, the indicated distance between the network entity 205 and the RIS 210 may satisfy the threshold distance. In such examples, the focusing distance for the link 220-b may correspond to a selected focusing distance (e.g., a same focusing distance as or a different focusing distance from the focusing distance that may be used for the link 220-b if the distance information is unavailable). In some other examples, the indicated distance may fail to satisfy the threshold distance. In such examples, the focusing distance for the link 220-b may be based on (e.g., may scale with) the distance between the network entity 205 and the RIS 210.

In some examples, whether the link 220-a is served via beamfocusing or beamforming may be based on an accuracy of the distance information 235. For example, the network entity 205 or the RIS 210 may determine that the accuracy of the distance information 235 satisfies a threshold accuracy. In such an example, the network entity 205 or the RIS 210 may determine the set of phase parameters based on the link 220-a being served via beamfocusing (e.g., in accordance with the available distance information). In some other examples, the network entity 205 or the RIS 210 may determine that the accuracy of the distance information 235 fails to satisfy the threshold accuracy. In such examples, the network entity 205 or the RIS 210 may determine the configuration based on the link 220-a being served via beamforming. In some examples, determining a focusing distance based on whether distance information between the network entity and the RIS is available may lead to reduced overhead and increased reliability of wireless communications between the network entity and the UE, among other benefits.

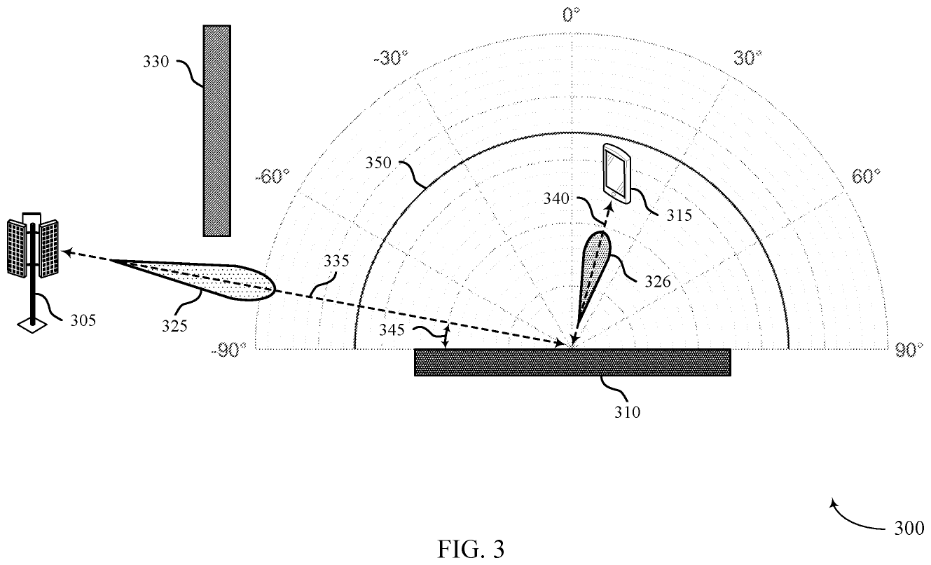

FIG. 3 shows an example of a wireless communications system 300 that supports RIS operations with an unknown transmission distance in accordance with one or more aspects of the present disclosure. In some examples, wireless communications system 300 may implement aspects of wireless communications system 100 and the wireless communications system 200. For instance, the wireless communications system 300 may include a network entity 305, a RIS 310, and a UE 315, which may be examples of the corresponding devices described with reference to FIGS. 1 and 2. The wireless communications system 300 may include features for improved communications between the UEs 315 and the network entity 305, among other benefits.

As illustrated in the example of FIG. 3, a direct path between the UE 315 and the network entity 305 may be obstructed by the blocker 330. As such, the network entity 305 may be unable to directly transmit signals to the UE 315. The blocker 330 may represent a physical obstruction, signal fading, or any other phenomenon or combination of phenomena that may cause communications between the network entity 305 and the UE 315 to experience signal loss or interference. In the example of FIG. 3, the blocker 330 may be a physical obstruction (e.g., buildings, mountains, people) positioned such that direct communications between the UE 315 and the network entity 305 may be impacted, such as by experiencing signal loss or interference (e.g., determined by the network entity 305 or the UE 315).

To correct signal loss or to otherwise improve spectral efficiency or reliability of the wireless connection between the network entity 305 and the UE 315, the network entity 305 may utilize additional wireless nodes to extend coverage and enhance communications with the UE 315. In some examples, such as to reduce deployment costs, the network entity 305 may employ a passive or near-passive wireless node, such as the RIS 310. That is, the network entity 305 may leverage the RIS 310 to circumvent the blocker 330 and steer signals from the network entity 305 towards the UE 315. In other words, the RIS 310 may include an array of passive and reconfigurable reflecting elements, which the network entity 305 may leverage to improve spectral efficiency (e.g., by circumventing blockages via new multipaths) at reduced (e.g., relatively low) deployment cost. As illustrated in the example of FIG. 3, the RIS 310 may steer incoming signals (e.g., an incident beam 325) from the network entity 305 towards the UE 315 via a reflected beam 326.

In some examples, a direction at which the RIS 310 may steer the reflected beam 326 may be based on a configuration of the RIS 310. For example, the RIS 310 may include a set of elements (e.g., passive, reconfigurable reflective elements) and the configuration may correspond to a phase matrix (e.g., a set of phase parameters) applied to the set of elements (e.g., to reflect incident signals). Accordingly, the phase matrix may include a set of elements (e.g., the set of parameters, a set of phase values) corresponding to the set of elements included in the RIS 310. In such examples, an element of the phase matrix (e.g., each element of the phase matrix) may correspond to (e.g., represent) a phase shift (e.g., a value of a phase shift) introduced by a respective element of the RIS 310 (e.g., introduced by the respective element of the RIS 310 to steer and shape the reflected beam 326). As such, a shape or direction (or both) of the reflected beam 326 may be based on the configuration (e.g., the phase matrix, the set of phase parameters) of the RIS 310. Accordingly, a received power of the reflected beam 326 at the UE 315 may be based on the configuration of the RIS 310.

In some examples, the RIS 310 or the network entity 305 (or both) may adjust (or select) a configuration of the RIS 310 to increase the received power of the reflected beam 326 at the UE 315. For example, an effective aperture size of the RIS 310 may be large relative to a transmit array (e.g., a transmit array associated with the network entity 305). In such examples, links associated with the RIS 310 (e.g., RIS assisted links), such as a first link between the network entity 305 and the RIS 310 and a second link between the RIS 310 and the UE 315, may experience near-field effects. That is, the RIS 310 may include an increased quantity of elements relative to a transmit array and, as such, a near field region of the RIS 310 may be large relative to the transmit array. In some examples, to improve a link quality of signals reflected via the RIS 310 (e.g., to increase the received power of the reflected beam 326 at the UE 315), the RIS 310 or the network entity 305 (or both) may adjust (or select) a configuration of the RIS 310 based on both angle information and distance information. In other words, a link quality of near-field communications (e.g., communications over the RIS-assisted links) may be improved (e.g., boosted) using beamfocusing in which the RIS 310 may shape the beam based on angle and distance information.

For example, in the near-field region, the UE 315 may modify the configuration of the RIS 310 based on angle information (e.g., an angle 345 of the incident beam 325 relative to the RIS 310) and distance information. The distance information may include a distance 335 between the network entity 305 and the UE 315 or a distance 340 between the RIS 310 and the UE 315, or both. In some examples, the distance 335 or the distance 340, or both, may be unavailable. That is, in some examples, distance information for either a transmitting device (e.g., the network entity 305, a gNB) or a receive device (e.g., the UE 315, an end UE) may not be available a priori, for example, considering a mobile RIS or a mobile smart repeater as the transmitter. In some examples, unavailable distance information may lead to increased difficulties for beamfocusing applications (e.g., may lead to beamfocusing applications becoming relatively difficult). In some examples, beamfocusing may be implemented without received device distance information, for example, if the distance between the transmit device and RIS 310 is available (e.g., precisely). That is, the RIS 310 may achieve beamfocusing for the second link between the RIS 310 and the UE 315 if at least the distance between the network entity 305 and the RIS 310 is known. In some examples, however, the distance between a transmit device (e.g., the network entity 305) and the RIS 310 may also be unavailable. For example, the RIS 310 may be mobile device (e.g., a device affixed to or otherwise associated with a vehicle) and a location of the RIS 310 be unknown or known imprecisely. As such, a distance between the RIS 310 and the network entity 305 (e.g., the distance 335) may be unknown or known relatively imprecisely.

In some examples, one or more techniques for RIS operations with an unknown transmission distance, as described herein, may provide for RIS beamfocusing operations with an unknown distance between the network entity 305 and the RIS 310. For example, such techniques may provide one or more beamfocusing strategies (e.g., strategies for using distance information and angle information to determine the RIS phase matrix) and respective signaling for examples in which the received device distance and the transmit device distance are not available. For example, one or more techniques for RIS operations with an unknown transmission distance, as described herein, may provide a hybrid scheme for RIS beam formation, in which the network entity 305 may use beamforming (e.g., without distance information) to serve a first link between the network entity 305 and the RIS 310 (e.g., a Tx-to-RIS link) and beamfocusing (e.g., to a static or fixed distance) to serve a second link between the RIS 310 and the UE 315 (e.g., a RIS-to-Rx link). That is, the RIS 310 or the network entity 305 may select a configuration (e.g., a phase matrix configuration, the set of phase parameters) of the RIS 310 to compensate for the RIS-to-Rx link and avoid (or reduce) a penalty in received power at the UE 315 (relative to a received power achievable by other schemes).

As illustrated in the example of FIG. 3, the network entity 305 may communicate with the UE 315 via the RIS 310. That is, the network entity 305 use the first link between the network entity 305 and the RIS 310 (e.g., a Tx-to-RIS link) and the second link between the RIS 310 and the UE 315 (e.g., a RIS-to-Rx link) to communicate with the UE 315. In some examples, the first link and the second link may be served by beamforming, beamfocusing, or a combination of beamforming and beamfocusing. That is, for either the first link (e.g., a Tx-to-RIS link) or the second link (e.g., a RIS-to-Rx link), the configuration of the RIS 310 may be based on beamforming or beamfocusing. In some examples, the first link or the second link (or both) may be served by a method (e.g., type) of beamfocusing in which a beam may be focused in accordance with a focusing distance that is based on distance information for the respective link (e.g., precise distance information for the respective link). As described herein, a method of beamfocusing in which a beam may be focused in accordance with a focusing distance that is based on distance information (e.g., relatively precise distance information) for the respective link may be referred to as distance refined beamfocusing or optimized beamfocusing (Optimized FO). For example, Optimized FO for the first link may include beamfocusing in accordance with a distance 335 (e.g., a relatively precise value of the distance 335) and Optimized FO for the second link may include beamfocusing in accordance with a distance 340 (e.g., a relatively precise value of the distance 340).

In some other examples, the first link or the second link (or both) may be served by a method (e.g., type) of beamfocusing in which a beam may be focused in accordance with a selected focusing distance for the respective link (e.g., a fixed focusing distance for the respective link, a pre-selected focusing distance (do) for the respective link, an approximate focusing distance for the respective link). As described herein, a method of beamfocusing in which a beam may be focused in accordance with a selected focusing distance may be referred to as single-point beamfocusing (Single-Point FO). That is, Single-Point FO for the first link may include beamfocusing in accordance with a first focusing distance (e.g., a preselected focusing distance) for the first link and Single-Point FO for the second link may include beamfocusing in accordance with a second focusing distance (e.g., another preselected focusing distance) for the second link. A value of the first focusing distance may be determined irrespective of a distance between the network entity 305 and the RIS 310 and a value of the second focusing distance may be determined irrespective of a distance between the RIS 310 and the UE 315. In some examples, the configuration for the RIS 310 may be in accordance with one or more option described in accordance with the following Table 1:

TABLE 1

| | First Link | Second Link |
|---|---|---|
| Option # | (Tx-to-RIS Link) | (RIS-to-Rx Link) |
| 1 | Optimized FO | Optimized FO |
| 2 | Optimized FO | Single-Point FO |
| 3 | Optimized FO | Beamforming |
| 4 | Single-Point FO | Single-Point FO |
| 5 | Single-Point FO | Beamforming |
| 6 | Beamforming | Single-Point FO |
| 7 | Beamforming | Beamforming |

In some examples, a method of beamfocusing used for a link may be based on an accuracy of available distance information. For example, the RIS 310 (or the network entity 305) may serve a link with Optimized FO if relatively precise distance information for the link is available and may serve a link with Single-Point FO if relatively imprecise distance information for the link is available. That is, the RIS 310 (or the network entity 305) may serve a link with Optimized FO in accordance with a focusing distance determined based on relatively precise distance information for the link. Additionally, or alternatively, the RIS 310 (or the network entity 305) may serve a link with Single-Point FO in accordance with a focusing distance determine based on approximate distance information for the link or with a focusing distance that may be determined irrespective of the distance information for the link. Additionally, or alternatively, the RIS 310 (or the network entity 305) may serve a link with beamforming if distance information for the link is unavailable. A received power attainable by beamforming may be reduced relative to beamfocusing (e.g., Optimized FO, Single-Point FO). In some examples, however, the network entity 305 may serve the first link (e.g., the Tx-to-RIS link) with beamforming without reducing the received power at the UE 315 (e.g., relative to a received power achieved at the UE 315 by serving the first link with Optimized FO or Single-Point FO). That is, if the distance 335 is unavailable the phase matrix for the RIS 310 may be determined such that the network entity 305 may serve the first link with beamforming (e.g., to avoid using transmission distance) without reducing the received power at the UE 315. In other words, if the distance 335 is unavailable and the RIS-to-Rx distance is also unavailable the phase matrix for the RIS 310 may be designed such that the network entity 305 may serve the first link with beamforming without reducing the received power at the UE 315, for example, relative to a received power attainable at the UE 315 by serving the Tx-to-RIS link with Optimized FO or Single-Point FO. For example, for some deployment geometries, the second link may be served by Single-Point FO with a focusing distance that may be determined irrespective of the distance 335 (e.g., may be independent of the distance 335). That is, to achieve such a performance for some deployment geometries (e.g., deployment geometries in which a transmitting device and the RIS 310 may be relatively far apart), the RIS-to-Rx link may be served by Single-Point FO with a focusing distance that may not be a function of the Tx-to-RIS distance.

In some examples of the wireless communications system 300, distance information between the network entity 305 and the RIS 310 may be unavailable (e.g., and therefore distance information between the RIS 310 and the UE 315 may also be unavailable). In such examples, the network entity 305 (e.g., and the RIS 310) may serve the first link via beamforming and the second link via Single-Point FO (e.g., may serving the first link and the second link in accordance with option 6 of Table 1). In other words, the Tx-to-RIS link may be served by beamforming (e.g., to avoid using transmission distance) and the RIS-to-Rx link may be served by Single-Point FO (e.g., with a fixed distance to focus). That is, the network entity 305 or the RIS 310 may determine a configuration for the RIS 310 (e.g., the phase matrix for the RIS 310, a set of phase parameters for the RIS 310) such that the first link may be served by beamforming and the second link may be served by Single-Point FO. In such an example, the beamfocusing for the first link may be based on (e.g., may account for, may consider) angle information. For example, the beamfocusing for the first link may be based on the angle 345. Additionally, the Single-Point FO may be based on a focusing distance 350, which may be selected irrespective of the distance 340. For example, the focusing distance 350 may be selected for multiple UEs (e.g., any UE) located in the direction of the UE 315. In such an example, the network entity 305 or the RIS 310 may determine the configuration for the RIS 310 (e.g., the phase matrix for the RIS 310, the set of phase parameters for the RIS 310) using the angle 345 and the focusing distance 350. In some examples, the network entity 305 (or the RIS 310) may determine (e.g., learn) a value of the angle 345 via beam sweeping procedure, such as via a procedure similar to synchronization signal block (SSB) transmissions used for initial discovery of a cell. In some examples, by serving the second link (e.g., the RIS-to-Rx link) with Single-Point FO with a suitable focusing distance the network entity 305 (and the RIS 310) may achieve a performance of Optimized FO by serving the first link (e.g., the Tx-to-RIS link) with beamforming. In other words, if the Tx-to-RIS link is served by beamforming, a same received power may be achieved at the UE 315 irrespective of whether the RIS-to-Rx link is served by Optimized FO or Single-Point FO.

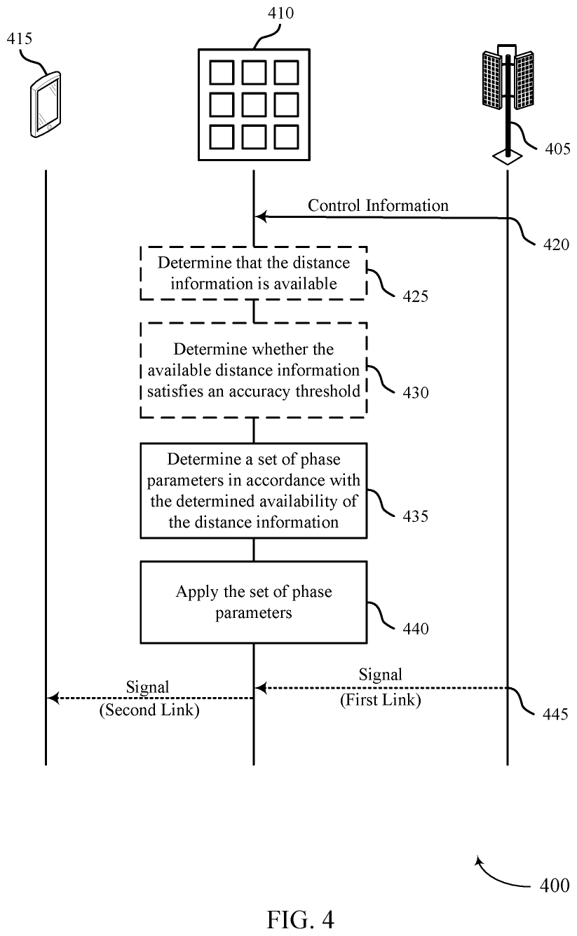

FIG. 4 shows an example of a process flow 400 that supports RIS operations with an unknown transmission distance in accordance with one or more aspects of the present disclosure. In some examples, the process flow 400 may implement one or more aspects of the wireless communications systems 100, the wireless communications systems 200, and the wireless communications system 300. For example, the process flow 400 may include example operations associated with a network entity 405 and a UE 415, which may be examples of the corresponding devices described with reference to FIGS. 1 through 3. Additionally, the process flow 400 may include example operations associated with a RIS 410, which may be an example of a RIS as described with reference to FIGS. 2 and 3. In the following description of the process flow 400, the operations between the network entity 405, the RIS 410, and the UE 415 may occur in a different order than the example order shown. Additionally, or alternatively, the operations performed by the network entity 405, the RIS 410, and the UE 415 may be performed in different orders or at different times. Some operations may be omitted and some operations may be combined. The operations performed by the network entity 405, the RIS 410, and the UE 415 may support improvements to communications between the UE 415 and the network entity 405, among other benefits. In the example of FIG. 4, the network entity 405 may communicate with the UE 415 via a first link between the network entity 405 and the RIS 410 (e.g., a Tx-to-RIS link) and a second link between the RIS 410 and the UE 415 (e.g., a RIS-to-Rx link).

The RIS 410 and the network entity 405 may support a framework for RIS beamfocusing operations with an unknown or relatively imprecise distance between the network entity 405 and the RIS 410. For example, the network entity 405 (e.g., a gNB) may serve the UE 415 using the RIS 410, which may be configured with a hybrid beam formation scheme (e.g., including beamfocusing) that may be based on whether distance information (e.g., relatively precise distance information) between the network entity 405 and the RIS 410 is available to the network entity 405 or the RIS 410 (or both). In other words, the network entity 405 or the RIS 410 (or both) may determine a set of phase parameters (e.g., a configuration (Φ), a phase matrix) for the RIS 410 in accordance with a hybrid beam formation scheme that may be based on whether the distance between the network entity 405 and the RIS 410 is available (e.g., known). For example, in accordance with the hybrid beam formation scheme, the RIS 410 may be configured such that the first link (e.g., the Tx-to-RIS link) may be served via beamforming or via beamfocusing based on whether the distance between the network entity 405 and the RIS 410 is available and the second link (e.g., the RIS-to-Rx link) may be served via beamfocusing in accordance with a focusing distance that may be based on whether the distance between the network entity 405 and the RIS 410 is available. In the example of FIG. 4, the distance information may be available and the RIS 410 may be configured such that the first link may be served via beamforming or beamfocusing based on the available distance information. Additionally, the RIS 410 may be configured such that the second link may be served via beamfocusing in accordance with a focusing distance that may be based on the available distance information.

In some examples, the network entity 405 may determine whether distance information between the network entity 405 and the RIS 410 is available based on an identifier of the RIS 410. For example, the network entity 405 may search an angular region with one or more downlink beams (e.g., downlink beams that the network entity 405 intends to use to serve the UE 415). That is, the network entity 405 may perform a search, such that the network entity 405 may detect a presence of a wireless node for communicating with the UE 415. In some examples, the network entity 405 may detect a presence of the RIS 410 for communicating with the UE 415. In response to detecting the RIS 410, the network entity 405 may determine whether distance information between the network entity 405 and the RIS 410 is available (e.g., may be obtained at the network entity 405). For example, network entity 405 may use an identifier associated with the RIS 410 (e.g., the detected wireless node) or other information (e.g., related feedback, beam reports) associated with the RIS 410 to determine whether distance information (e.g., relatively precise distance information) between the network entity 405 and the RIS 410 may be obtained. That is, the network entity 405 may check if the Tx-to-RIS distance (e.g., relatively precise Tx-to-RIS distance) may be obtained based on the identity of the RIS 410 or other related feedback and beam reports. In other words, the network entity 405 may determine whether Tx-to-RIS distance information may be obtained based on the identity of the RIS 410 or other (e.g., any other) related feedback and beam reports, such as feedback or beam reports from the UE 415 or the RIS 410.

At 420, the RIS 410 may receive control information from the network entity 405. The RIS 410 may use the control information for determination of the set of phase parameters at the RIS 410. For example, the control information may indicate the set of phase parameters. In some other examples, the control information may indicate an angular direction (e.g., and the distance information, if available) for determining the set of phase parameters (e.g., at the RIS 410). In some examples, the RIS 410 may receive downlink control information (DCI) or a radio resource control (RRC) message that includes the control information. That is, in some examples, the network entity 405 (e.g., the gNB) may informs the RIS 410 of a suitable beam (e.g., the set of phase parameters used to generate a suitable beam) either dynamically (e.g., via DCI) or semi-statically (e.g., via RRC messages). In some other examples, the network entity 405 may send angular direction (e.g., or a set of directions) and the gNB-to-RIS distance (e.g., if available) to the RIS 410 (e.g., to a RIS controller at the RIS 410). In such examples, the RIS 410 may then computes (or select from precomputed values) a suitable focusing distance to use for the beamfocusing operation for the RIS-to-Rx link (e.g., the RIS-to-UE link). In other words, the RIS 410 may determine the set of phase parameters in accordance with a focusing distance that may be computed or select from a set of precomputed values based on the indicated angle and distance information.

In some examples, at 425, the RIS 410 may determine that the distance information between the network entity 405 and the RIS 410 is available. For example, the control information received at 420 may indicate the set of phase parameters. The indicated set of phase parameters may be based on the available distance information. That is, the indicated set of phase parameters may be based on the second link being served via beamfocusing in accordance with a focusing distance that may be based on the available distance information. In other words, the indicated set of phase parameters may be constructed at the network entity 405 such that the second link (e.g., the RIS-to-Rx link, the RIS-to-UE channel) may be served via beamfocusing to a focusing distance (e.g., a fixed focusing distance) selected based on the available distance information. In such examples, the RIS 410 may determine that the distance information is available based on the indicated set of phase parameters. In some other examples, the control information may indicate the distance information. For example, the control information may include an indication of distance information and the angular direction information for determination (e.g., construction) of the set of phase parameters at the RIS 410. In such examples, the RIS 410 may determine that the distance information is available based on the indication. Accordingly, the RIS 410 may determine (e.g., construct) the set of phase parameters (e.g., the RIS phase matrix) such that the second link (e.g., RIS-to-Rx link, the RIS-to-UE channel) may be served via beamfocusing to a focusing distance (e.g., a fixed focusing distance) selected based on the available distance information. In some other examples, the RIS 410 or the network entity 405 may select the focusing distance (e.g., a value for the focusing distance) based on whether the available distance information satisfies an accuracy threshold.

For example, at 430, the RIS 410 may determine whether an accuracy of the available distance information satisfies the accuracy threshold. In such an example, the set of phase parameters may be based on whether the accuracy satisfies the accuracy threshold. For example, the RIS 410 or the network entity 405 may select a first value (e.g., about 20 m or some other suitable value) for the focusing distance based on the available distance information satisfying the accuracy threshold. In other words, the network entity 405 may identify the RIS 410 and may obtain information indicative of a distance between the network entity 405 and the RIS 410. In some examples, the network entity 405 or the RIS 410 may determine that the obtained distance information satisfies the accuracy threshold, such that a relatively precise distance between the RIS 410 and the network entity 405 may be determined. In such an example, the set of phase parameters (e.g., the phase matrix) for the RIS 410 may be configured such that the first link between the network entity 405 and the RIS 410 (e.g., the Tx-to-RIS link, the gNB-to-RIS channel) may be served by beamfocusing in accordance with the determined distance (e.g., with gNB-to-RIS distance and the respective angle). Additionally, the set of phase parameters for the RIS 410 may be configured such that and the second link between the RIS 410 and the UE 415 (e.g., the RIS-to-Rx link, the RIS-to-UE channel) may be served by beamfocusing in accordance with the first value (e.g., about 20 m or some other suitable value). In other words, the set of phase parameters may be determined such that the first link may be served via Optimized FO in accordance with a first focusing distance set to the determined distance between the network entity 405 and the RIS 410 and the second link may be served via Single-Point FO in accordance with a second focusing distance set to the first value (e.g., a preselected value, a configured value).

In some other examples, the network entity 405 or the RIS 410 may determine that the available distance information fails to satisfy the accuracy threshold, such that a relatively imprecise distance between the network entity 405 and the RIS 410 may be determined. In such an example, the set of phase parameters (e.g., the phase matrix) for the RIS may be configured such that the first link may be served by beamforming (e.g., using respective angle information) and the second link may be served by beamfocusing in accordance with a focusing distance set to a value selected based on the determined distance between the network entity 405 and the RIS 410. In other words, the set of phase parameters may be determined such that the first link may be served via beamforming and the second link may be served via Single-Point FO in accordance with a focusing distance set to the selected value.

In some examples, the accuracy threshold may be based on the distance between the network entity 405 and the RIS 410. For example, the RIS 410 or the network entity 405 may determine the distance between the network entity 405 and the RIS 410 based on the available distance information. Additionally, the RIS 410 or the network entity 405 may determine (e.g., select) the accuracy threshold based on the determined distance. In some examples, the determined distance may be relatively small. In such examples, the RIS 410 (or the network entity 405) may select a value for the accuracy threshold, such that a likelihood of the threshold being satisfied may be increased. That is, for examples in which the network entity 405 may be relatively close-in (e.g., for gNBs that may be located a relatively short distance from the RIS 410), the value of the accuracy threshold may favor beamfocusing. In other words, the value of the accuracy threshold may favor beamfocusing at relatively short transmission distances, for example, due a gain achievable by beamfocusing increasing as the distance between the network entity 405 and the RIS 410 decrease or due to a focusing distance used for the second link being impacted more by an imprecise transmission distance (e.g., if the first link is served via beamforming than if the first link is served via beamfocusing). In other words, the accuracy threshold may become less constraining as a distance between the network entity 405 and the RIS 410 decreases. For example, the value of the accuracy threshold may decrease as the distance between the network entity 405 and the RIS 410 decreases.

In some examples, a value selected for a focusing distance may be based on whether the distance between the network entity 405 and the RIS 410 satisfies a distance threshold. For example, the RIS 410 or the network entity 405 may determine the distance between the network entity 405 and the RIS 410 based on the available distance information. In some examples, the second link may be served via beamfocusing and a value selected for the focusing distance may be based on whether the distance satisfies a distance threshold. For example, the RIS 410 or the network entity 405 may determine that the distance between the network entity 405 and the RIS 410 satisfies the distance threshold (e.g., is greater than about 20 m or some other suitable distance). In such an example, the RIS 410 or the network entity 405 may select a first value (e.g., about 17 m or some other suitable value) for the focusing distance. In some examples, the RIS 410 or the network entity 405 may determine that the distance between the network entity 405 and the RIS 410 fails to satisfy the distance threshold (e.g., is less than or equal to about 20 m or some other suitable distance). In such examples, the RIS 410 (or the network entity 405) may select a value for the focusing distance based on the distance between the network entity 405 and the RIS 410. In some examples, the selected value for the focusing distance may decrease as the distance between network entity 405 and the UE 415 decreases.

At 435, the RIS 410 may determine the set of phase parameters in accordance with the determined availability of the distance information. In some examples, the control information received at 420 may indicate the set of phase parameters. In such examples, the RIS 410 may determine the set of phase parameters in accordance with the indicated set of phase parameters. For example, the RIS 410 may use the indicated set of phase parameters or the RIS 410 may determine to use another set of phase parameters that may be based on the indicated set of phase parameters. In some other examples, the control information may indicate angular direction information or the distance information (or both). In such examples, the RIS 410 may determine (e.g., calculate) the set of phase parameters based on the indicated angular direction information or the indicated distance information, or both. Additionally, in some examples, the RIS 410 may determine the set of phase parameters in accordance with the determination at 430. That is, the set of phase parameters may be constructed at the RIS 410 or the network entity 405 based on the first link being served via beamforming or beamfocusing based on whether the accuracy of the available distance information satisfies the accuracy threshold and the second link being served via beamfocusing in accordance with a focusing distance that may be based on whether the accuracy of the available distance information satisfies the accuracy threshold.

For example, the set of phase parameters may be constructed such that the second link (e.g., the RIS-to-UE channel) may be served via beamfocusing in accordance with a focusing distance, which may depend on the RIS 410 (e.g., an aperture size of the RIS 410, element spacing of the RIS 410), communication settings (e.g., a frequency, such as a frequency of communications being transmitted via the RIS 410), an engagement geometry (e.g., an incident/reflection angle pair), and whether the distance information is available. That is, the focusing distance may be based on whether the distance information (e.g., the gNB-to-RIS distance) is available and, in some examples, whether the available distance information satisfies the accuracy threshold. In some examples, the RIS 410 or the network entity 405 may select a value (e.g., a configured value, such as about 20 m or some other suitable value) for the focusing distance based on the distance information being available. Additionally, in some examples, the selected value may be based on a distance indicated via the available distance information or whether the available distance information satisfies an accuracy threshold, or both.

At 440, the RIS 410 may apply the set of phase parameters to reflect a signal from the network entity 405 to the UE 415 via the RIS 410. For example, the RIS 410 may apply the set of phase parameters to a set of elements included in RIS 410 (e.g., in the surface of the RIS 410), such that the RIS 410 may reflect the signal (e.g., communication) from the network entity 405 to the UE 415 in accordance with the focusing distance that is based on the available distance information.

For example, at 445, the network entity 405 may transmit the signal towards the RIS 410 via the first link and the RIS 410 may reflect the signal towards the UE 415 via the second link. In such an example, the signal transmitted from the network entity 405 via the first link may be transmitted at the network entity 405 using beamforming in accordance with the angle information or using beamfocusing in accordance with the angle information and the available distance information. Additionally, the signal reflected from the RIS 410 via the second link may be reflected at the RIS 410 using beamfocusing in accordance with the focusing distance that may be based on the available distance information. In some examples, serving the second link via beamfocusing in accordance with a focusing distance that may be based on the available distance information may lead to an increased received power at the UE 415 and increased reliability of wireless communications between the UE 415 and the network entity 405, among other benefits.

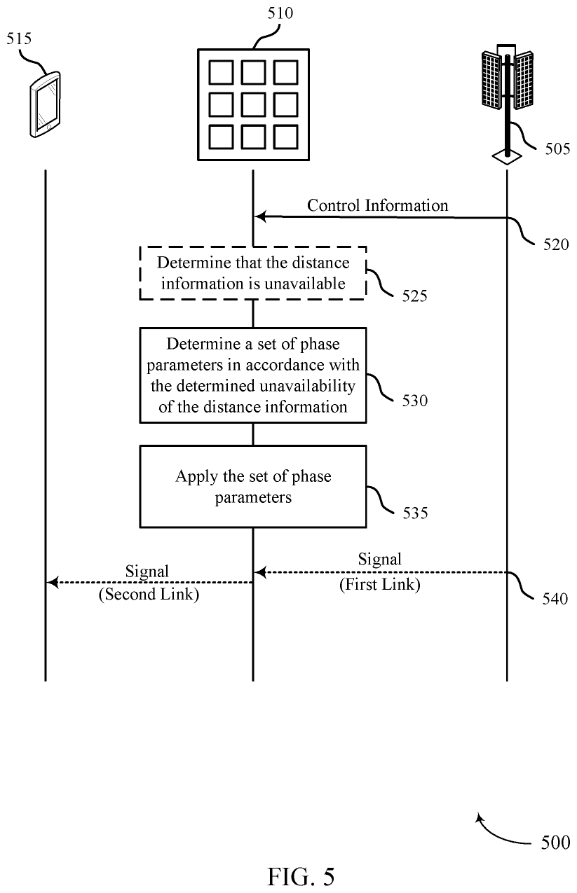

FIG. 5 shows an example of a process flow 400 that supports RIS operations with an unknown transmission distance in accordance with one or more aspects of the present disclosure. For example, the process flow 500 may include example operations associated with a network entity 505 and a UE 515, which may be examples of the corresponding devices described with reference to FIGS. 1 through 4. Additionally, the process flow 500 may include example operations associated with a RIS 510, which may be an example of a RIS as described with reference to FIGS. 2 through 4. In the following description of the process flow 500, the operations between the network entity 505, the RIS 510, and the UE 515 may occur in a different order than the example order shown. Additionally, or alternatively, the operations performed by the network entity 505, the RIS 510, and the UE 515 may be performed in different orders or at different times. Some operations may be omitted and some operations may be combined. The operations performed by the network entity 505, the RIS 510, and the UE 515 may support improvements to communications between the UE 515 and the network entity 505, among other benefits. In the example of FIG. 5, the network entity 505 may communicate with the UE 515 via a first link between the network entity 505 and the RIS 510 (e.g., a Tx-to-RIS link) and a second link between the RIS 510 and the UE 515 (e.g., a RIS-to-Rx link).

The RIS 510 and the network entity 505 may support a framework for RIS beamfocusing operations with an unknown distance between the network entity 505 and the RIS 510. For example, the RIS 510 may be configured such that the first link (e.g., the Tx-to-RIS link) may be served via beamforming and the second link (e.g., the RIS-to-Rx link) may be served via beamfocusing in accordance with a focusing distance that may be based on the distance between the network entity 405 and the RIS 410 being unknown (e.g., unavailable).

In some examples, the network entity 505 may search an angular region with one or more downlink beams (e.g., downlink beams that the network entity 505 intends to use to serve the UE 515) and detect a presence of the RIS 510 for communicating with the UE 515. In response to detecting the RIS 510, the network entity 505 may determine that distance information between the network entity 505 and the RIS 510 is unavailable (e.g., may not be obtained at the network entity 505). For example, the network entity 505 may determine that the distance between the network entity 505 and the RIS 510 (e.g., the Tx-to-RIS distance) may not be obtained based on the identity of the RIS 410 or other related feedback and beam reports (e.g., from the UE 515 or the RIS 510).

At 520, the RIS 510 may receive control information from the network entity 505. The RIS 510 may use the control information for determination of the set of phase parameters at the RIS 510. For example, the control information may indicate the set of phase parameters. In some other examples, the control information may indicate an angular direction for determination of the set of phase parameters (e.g., at the RIS 510). In some examples, the RIS 510 may receive DCI or an RRC message that includes the control information.

In some examples, at 525, the RIS 410 may determine that the distance information between the network entity 405 and the RIS 410 is unavailable. For example, the control information received at 520 may indicate the set of phase parameters and the indicated set of phase parameters may be based on the unavailability of the distance information. That is, the indicated set of phase parameters may be based on the second link being served via beamfocusing in accordance with a focusing distance that may be based on the distance information being unavailable (e.g., unknown). In such examples, the RIS 510 may determine that the distance information is unavailable based on the indicated set of phase parameters. In some other examples, the control information may lack an indication of the distance information. For example, the control information may include an indication of the angular direction information for determination of the set of phase parameters at the RIS 510. In such examples, the RIS 510 may determine that the distance information is unavailable based on the lack of the indication of the distance information.

At 530, the RIS 510 may determine the set of phase parameters in accordance with the determined unavailability of the distance information. In some examples, the control information received at 520 may indicate the set of phase parameters. In such examples, the RIS 510 may determine the set of phase parameters in accordance with the indicated set of phase parameters. For example, the RIS 510 may determine to use the indicated set of phase parameters or the RIS 510 may determine to use another set of phase parameters that may be based on the indicated set of phase parameters. In some other examples, the control information may indicate the angular direction information. In such examples, the RIS 510 may determine (e.g., calculate) the set of phase parameters based on the indicated angular direction. Additionally, in some examples, the RIS 510 may determine the set of phase parameters in accordance with the determination at 525. That is, the set of phase parameters may be constructed at the RIS 510 (or the network entity 505) based on the first link being served via beamforming based on the unavailability of the distance information and the second link being served via beamfocusing in accordance with a focusing distance that may be based on the unavailability of the distance information. For example, the set of phase parameters may be constructed such that the second link (e.g., the RIS-to-UE channel) may be served via beamfocusing in accordance with a focusing distance, which may depend on the RIS 510 (e.g., an aperture size of the RIS 510, element spacing of the RIS 510), communication settings (e.g., a frequency, such as a frequency of communications being transmitted via the RIS 510), an engagement geometry (e.g., an incident/reflection angle pair), and whether the distance information is available. In some examples, the RIS 510 or the network entity 505 may select a value (e.g., a configured value, such as about 17 m or some other suitable value) for the focusing distance based on the distance information being unavailable. In other words, the set of phase parameters may be determined such that the first link may be served via beamforming and the second link may be served via Single Point FO in accordance with a focusing distance set to a value selected based on the distance information being unavailable.

At 535, the RIS 510 may apply the set of phase parameters to reflect a signal from the network entity 505 to the UE 515 via the RIS 510. For example, the RIS 510 may apply the set of phase parameters to a set of elements included in RIS 510 (e.g., in the surface of the RIS 510), such that the RIS 510 may reflect the signal (e.g., communication) from the network entity 505 to the UE 515 in accordance with the focusing distance that is based on the distance information being unavailable.

For example, at 540, the network entity 505 may transmit the signal towards the RIS 510 via the first link and the RIS 510 may reflect the signal towards the UE 515 via the second link. In such an example, the signal transmitted from the network entity 505 via the first link may be transmitted at the network entity 505 using beamforming in accordance with the angle information (e.g., indicated via the control information). Additionally, the signal reflected from the RIS 510 via the second link may be reflected at the RIS 510 using beamfocusing in accordance with the focusing distance that may be based on the distance information being unavailable. In some examples, serving the second link via beamfocusing in accordance with a focusing distance based on the distance information being unavailable may lead to an increased received power at the UE 515 and increased reliability of wireless communications between the UE 515 and the network entity 505, among other benefits.

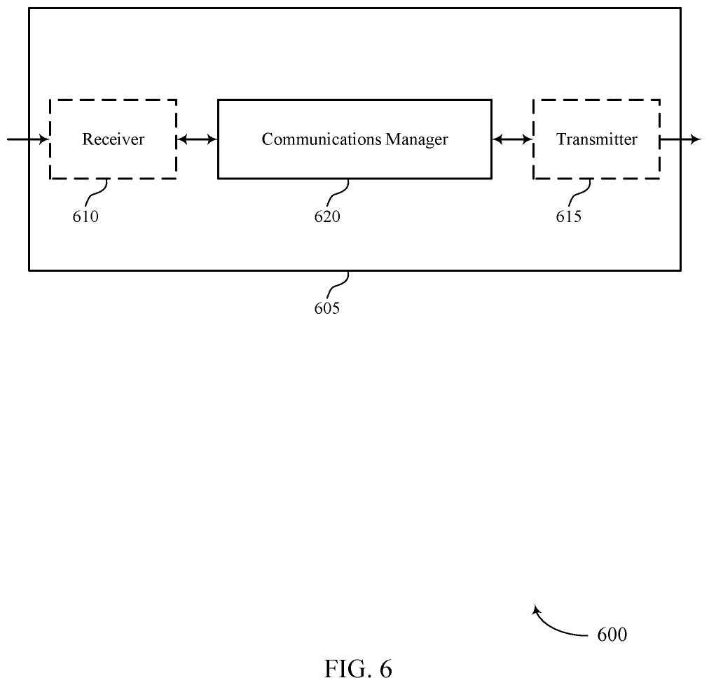

FIG. 6 shows a block diagram 600 of a device 605 that supports RIS operations with an unknown transmission distance in accordance with one or more aspects of the present disclosure. The device 605 may be an example of aspects of a RIS as described herein. The device 605 may include a receiver 610, a transmitter 615, and a communications manager 620. The device 605 may also include at least one processor. Each of these components may be in communication with one another (e.g., via one or more buses).

The receiver 610 may provide a means for receiving information such as packets, user data, control information, or any combination thereof associated with various information channels (e.g., control channels, data channels, information channels related to RIS operations with an unknown transmission distance). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RIS operations with an unknown transmission distance). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of RIS operations with an unknown transmission distance as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include at least one processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, in some examples, the communications manager 620, the receiver 610, the transmitter 615, or various combinations or components thereof may be implemented in code (e.g., as communications management software or firmware) executed by at least one processor. If implemented in code executed by a at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a RIS (e.g., the device 605) in accordance with examples as disclosed herein. For example, the communications manager 620 is capable of, configured to, or operable to support a means for receiving, from a network entity, control information for determination of a set of phase parameters at the RIS. The communications manager 620 is capable of, configured to, or operable to support a means for determining whether distance information between the network entity and the RIS is available. The communications manager 620 is capable of, configured to, or operable to support a means for determining the set of phase parameters for the RIS in accordance with the control information, the set of phase parameters is usable by the RIS for reflecting communications from the network entity to a UE in accordance with a focusing distance that is based on the determined availability of the distance information. The communications manager 620 is capable of, configured to, or operable to support a means for applying the set of phase parameters to reflect a signal from the network entity to the UE via the RIS.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing and more efficient utilization of communication resources.

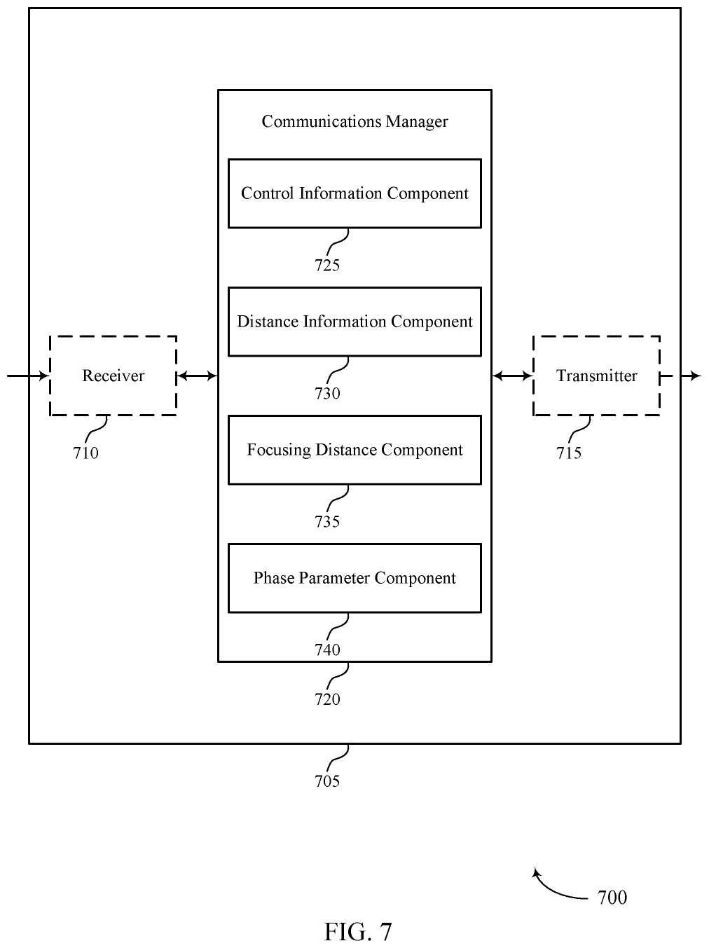

FIG. 7 shows a block diagram 700 of a device 705 that supports RIS operations with an unknown transmission distance in accordance with one or more aspects of the present disclosure. The device 705 may be an example of aspects of a device 605 or a RIS as described herein. The device 705 may include a receiver 710, a transmitter 715, and a communications manager 720. The device 705 may also include at least one processor. Each of these components may be in communication with one another (e.g., via one or more buses).

The receiver 710 may provide a means for receiving information such as packets, user data, control information, or any combination thereof associated with various information channels (e.g., control channels, data channels, information channels related to RIS operations with an unknown transmission distance). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RIS operations with an unknown transmission distance). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of RIS operations with an unknown transmission distance as described herein. For example, the communications manager 720 may include a control information component 725, a distance information component 730, a focusing distance component 735, a phase parameter component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a RIS (e.g., the device 705) in accordance with examples as disclosed herein. The control information component 725 is capable of, configured to, or operable to support a means for receiving, from a network entity, control information for determination of a set of phase parameters at the RIS. The distance information component 730 is capable of, configured to, or operable to support a means for determining whether distance information between the network entity and the RIS is available. The focusing distance component 735 is capable of, configured to, or operable to support a means for determining the set of phase parameters for the RIS in accordance with the control information, the set of phase parameters is usable by the RIS for reflecting communications from the network entity to a UE in accordance with a focusing distance that is based on the determined availability of the distance information. The phase parameter component 740 is capable of, configured to, or operable to support a means for applying the set of phase parameters to reflect a signal from the network entity to the UE via the RIS.

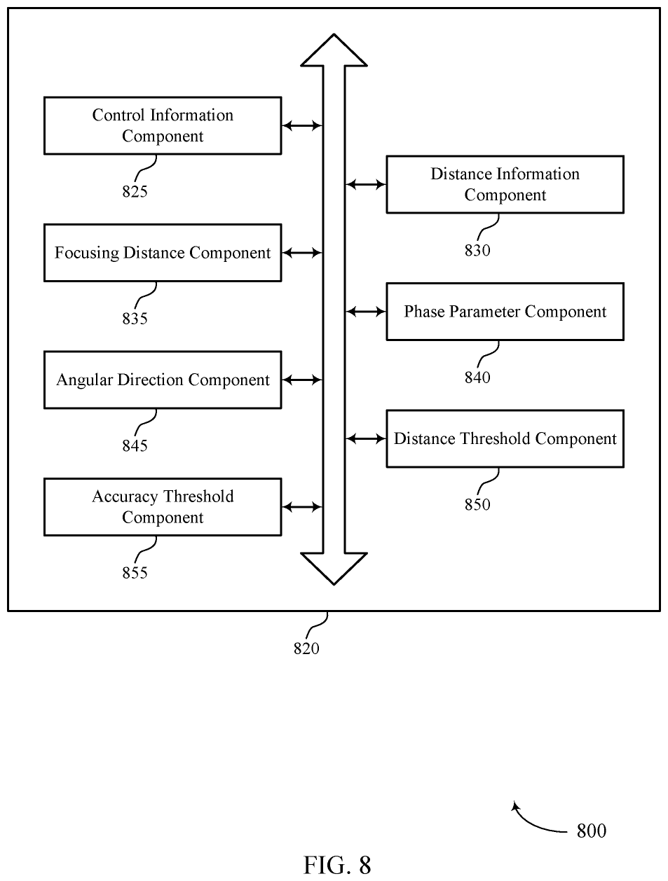

FIG. 8 shows a block diagram 800 of a communications manager 820 that supports RIS operations with an unknown transmission distance in accordance with one or more aspects of the present disclosure. The communications manager 820 may be an example of aspects of a communications manager 620, a communications manager 720, or both, as described herein. The communications manager 820, or various components thereof, may be an example of means for performing various aspects of RIS operations with an unknown transmission distance as described herein. For example, the communications manager 820 may include a control information component 825, a distance information component 830, a focusing distance component 835, a phase parameter component 840, an angular direction component 845, a distance threshold component 850, an accuracy threshold component 855, or any combination thereof. Each of these components may communicate, directly or indirectly, with one another (e.g., via one or more buses).

The communications manager 820 may support wireless communications at a RIS in accordance with examples as disclosed herein. The control information component 825 is capable of, configured to, or operable to support a means for receiving, from a network entity, control information for determination of a set of phase parameters at the RIS. The distance information component 830 is capable of, configured to, or operable to support a means for determining whether distance information between the network entity and the RIS is available. The focusing distance component 835 is capable of, configured to, or operable to support a means for determining the set of phase parameters for the RIS in accordance with the control information, the set of phase parameters is usable by the RIS for reflecting communications from the network entity to a UE in accordance with a focusing distance that is based on the determined availability of the distance information. The phase parameter component 840 is capable of, configured to, or operable to support a means for applying the set of phase parameters to reflect a signal from the network entity to the UE via the RIS.

In some examples, to support receiving the control information, the control information component 825 is capable of, configured to, or operable to support a means for receiving an indication of the set of phase parameters.

In some examples, to support receiving the control information, the angular direction component 845 is capable of, configured to, or operable to support a means for receiving an indication of an angular direction for determining of the set of phase parameters.

In some examples, the distance information component 830 is capable of, configured to, or operable to support a means for receiving an indication of the distance information, where determining the set of phase parameters is based on the distance information.

In some examples, to support receiving the control information, the control information component 825 is capable of, configured to, or operable to support a means for receiving DCI or an RRC message including the control information.

In some examples, the distance information component 830 is capable of, configured to, or operable to support a means for determining that the distance information is available, where the focusing distance is based on the available distance information, and where the set of phase parameters is based on a first link between the RIS and the UE being served via beamfocusing in accordance with the focusing distance.

In some examples, the distance threshold component 850 is capable of, configured to, or operable to support a means for determining a distance between the network entity and the RIS based on the available distance information, where the focusing distance is based on whether the distance satisfies a distance threshold.

In some examples, the accuracy threshold component 855 is capable of, configured to, or operable to support a means for determining whether an accuracy of the available distance information satisfies an accuracy threshold, where the set of phase parameters is based on whether the accuracy satisfies the accuracy threshold.

In some examples, the accuracy threshold component 855 is capable of, configured to, or operable to support a means for determining that the accuracy of the available distance information satisfies the accuracy threshold, where the set of phase parameters is based on a second link between the network entity and the RIS being served via beamfocusing in accordance with the available distance information.

In some examples, the accuracy threshold component 855 is capable of, configured to, or operable to support a means for determining that the accuracy of the available distance information fails to satisfy the accuracy threshold, where the set of phase parameters is based on a second link between the network entity and the RIS being served via beamforming.

In some examples, the accuracy threshold component 855 is capable of, configured to, or operable to support a means for determining a distance between the network entity and the RIS based on the available distance information, where the accuracy threshold is based on the determined distance.

In some examples, the distance information component 830 is capable of, configured to, or operable to support a means for determining that the distance information is unavailable, where the focusing distance is based on the distance information being unavailable, and where the set of phase parameters is based on a first link between the RIS and the UE being served via beamfocusing in accordance with the focusing distance and a second link between the network entity and the RIS being served via beamforming.

In some examples, the focusing distance is based on one or more parameters associated with the RIS, one or more parameters associated with the communications from the network entity, or a geometry of an incident and reflected angle pair, or any combination thereof.

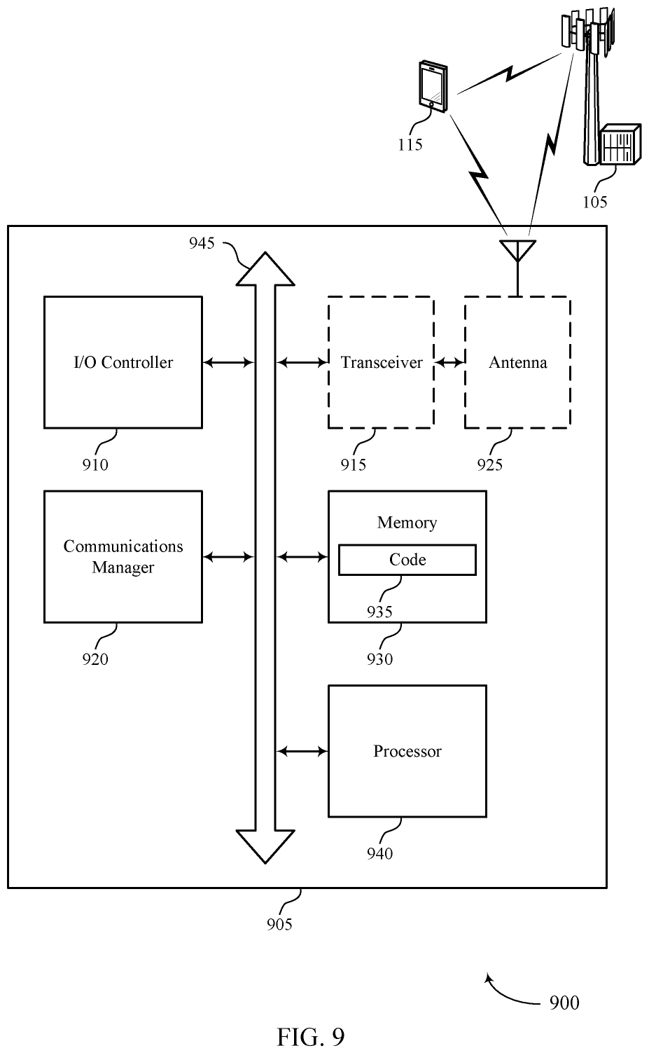

FIG. 9 shows a diagram of a system 900 including a device 905 that supports RIS operations with an unknown transmission distance in accordance with one or more aspects of the present disclosure. The device 905 may be an example of or include the components of a device 605, a device 705, or a RIS as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least a memory 930, code 935, and at least a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of at least one processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). At least the memory 930 may store computer-readable, computer-executable code 935 including instructions that, when executed by at least the processor 940, cause the device 905 to perform various functions described herein. The code 935 may be stored in a non-transitory computer-readable medium such as system memory or another type of memory. In some cases, the code 935 may not be directly executable by at least the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate at least one memory array using a memory controller. In some other cases, a memory controller may be integrated into at least the processor 940. The processor 940 may be configured to execute computer-readable instructions stored in at least one memory (e.g., the memory 930) to cause the device 905 to perform various functions (e.g., functions or tasks supporting RIS operations with an unknown transmission distance). For example, the device 905 or a component of the device 905 may include at least a processor 940 and memory 930 coupled with or to at least the processor 940, the processor 940 and memory 930 configured to perform various functions described herein.

The communications manager 920 may support wireless communications at a RIS (e.g., the device 905) in accordance with examples as disclosed herein. For example, the communications manager 920 is capable of, configured to, or operable to support a means for receiving, from a network entity, control information for determination of a set of phase parameters at the RIS. The communications manager 920 is capable of, configured to, or operable to support a means for determining whether distance information between the network entity and the RIS is available. The communications manager 920 is capable of, configured to, or operable to support a means for determining the set of phase parameters for the RIS in accordance with the control information, the set of phase parameters is usable by the RIS for reflecting communications from the network entity to a UE in accordance with a focusing distance that is based on the determined availability of the distance information. The communications manager 920 is capable of, configured to, or operable to support a means for applying the set of phase parameters to reflect a signal from the network entity to the UE via the RIS.

By including or configuring the communications manager 920 in accordance with examples as described herein, the device 905 may support techniques for improved communication reliability, reduced latency, improved user experience related to reduced processing, reduced power consumption, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by at least the processor 940, at least the memory 930, the code 935, or any combination thereof. For example, the code 935 may include instructions executable by at least the processor 940 to cause the device 905 to perform various aspects of RIS operations with an unknown transmission distance as described herein, or at least the processor 940 and at least the memory 930 may be otherwise configured to perform or support such operations.

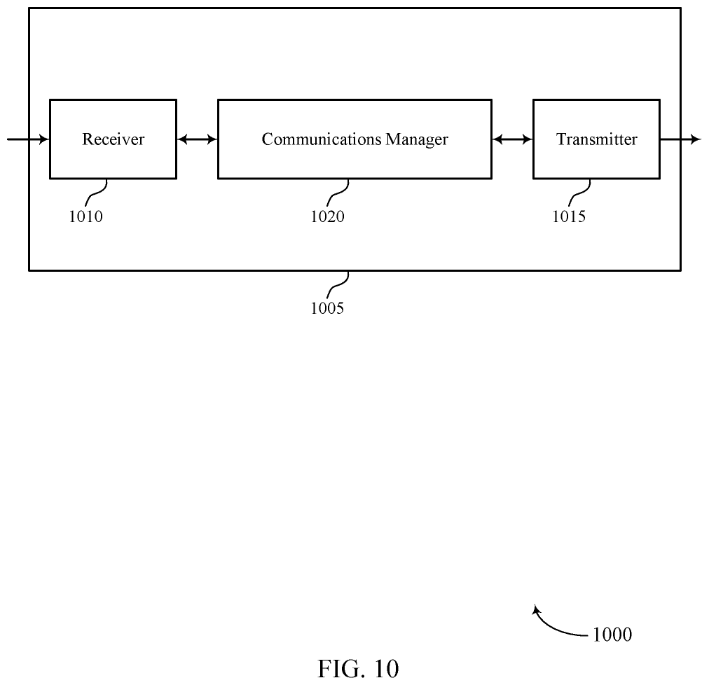

FIG. 10 shows a block diagram 1000 of a device 1005 that supports RIS operations with an unknown transmission distance in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include at least one processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of RIS operations with an unknown transmission distance as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include at least one processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, in some examples, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity (e.g., the device 1005) in accordance with examples as disclosed herein. For example, the communications manager 1020 is capable of, configured to, or operable to support a means for detecting a presence of a RIS for communicating with a UE. The communications manager 1020 is capable of, configured to, or operable to support a means for determining whether distance information between the network entity and the RIS is available. The communications manager 1020 is capable of, configured to, or operable to support a means for outputting control information associating with a set of phase parameters for the RIS, the set of phase parameters is usable by the RIS for reflecting communications from the network entity to the UE in accordance with a focusing distance that is based on the determined availability of the distance information. The communications manager 1020 is capable of, configured to, or operable to support a means for communicating a signal with the UE via the RIS in accordance with the set of phase parameters.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing and more efficient utilization of communication resources.

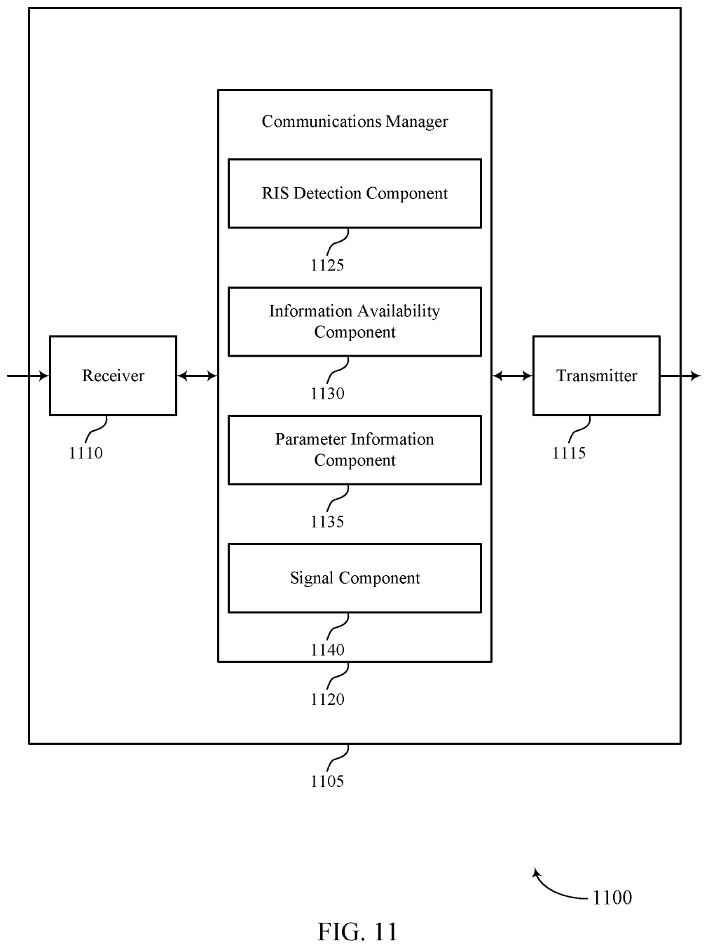

FIG. 11 shows a block diagram 1100 of a device 1105 that supports RIS operations with an unknown transmission distance in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include at least one processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of RIS operations with an unknown transmission distance as described herein. For example, the communications manager 1120 may include a RIS detection component 1125, an information availability component 1130, a parameter information component 1135, a signal component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity (e.g., the device 1105) in accordance with examples as disclosed herein. The RIS detection component 1125 is capable of, configured to, or operable to support a means for detecting a presence of a RIS for communicating with a UE. The information availability component 1130 is capable of, configured to, or operable to support a means for determining whether distance information between the network entity and the RIS is available. The parameter information component 1135 is capable of, configured to, or operable to support a means for outputting control information associated with a set of phase parameters for the RIS, the set of phase parameters is usable by the RIS for reflecting communications from the network entity to the UE in accordance with a focusing distance that is based on the determined availability of the distance information. The signal component 1140 is capable of, configured to, or operable to support a means for communicating a signal with the UE via the RIS in accordance with the set of phase parameters.

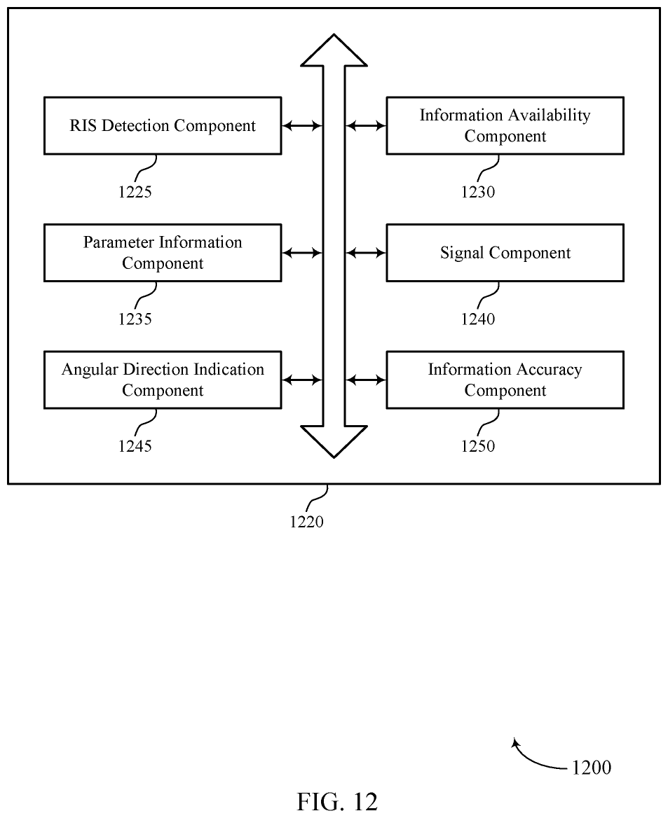

FIG. 12 shows a block diagram 1200 of a communications manager 1220 that supports RIS operations with an unknown transmission distance in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of RIS operations with an unknown transmission distance as described herein. For example, the communications manager 1220 may include a RIS detection component 1225, an information availability component 1230, a parameter information component 1235, a signal component 1240, an angular direction indication component 1245, an information accuracy component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The RIS detection component 1225 is capable of, configured to, or operable to support a means for detecting a presence of a RIS for communicating with a UE. The information availability component 1230 is capable of, configured to, or operable to support a means for determining whether distance information between the network entity and the RIS is available. The parameter information component 1235 is capable of, configured to, or operable to support a means for outputting control information associated with a set of phase parameters for the RIS, the set of phase parameters is usable by the RIS for reflecting communications from the network entity to the UE in accordance with a focusing distance that is based on the determined availability of the distance information. The signal component 1240 is capable of, configured to, or operable to support a means for communicating a signal with the UE via the RIS in accordance with the set of phase parameters.

In some examples, the information availability component 1230 is capable of, configured to, or operable to support a means for determining the set of phase parameters for the RIS based on the determined availability of the distance information.

In some examples, to support outputting the control information, the parameter information component 1235 is capable of, configured to, or operable to support a means for outputting an indication of the determined set of phase parameters.

In some examples, to support outputting the control information, the angular direction indication component 1245 is capable of, configured to, or operable to support a means for outputting a first indication of an angular direction for determination of the set of phase parameters.

In some examples, the information availability component 1230 is capable of, configured to, or operable to support a means for determining that the distance information is available. In some examples, the parameter information component 1235 is capable of, configured to, or operable to support a means for outputting a second indication of the available distance information for the determination of the set of phase parameters.

In some examples, to support outputting the control information, the parameter information component 1235 is capable of, configured to, or operable to support a means for outputting DCI or an RRC message including the control information.

In some examples, the information availability component 1230 is capable of, configured to, or operable to support a means for determining that the distance information is available, where the focusing distance is based on the available distance information, and where the set of phase parameters is based on a first link between the RIS and the UE being served via beamfocusing in accordance with the focusing distance.

In some examples, the information availability component 1230 is capable of, configured to, or operable to support a means for determining a distance between the network entity and the RIS based on the available distance information, where the focusing distance is based on whether the distance satisfies a distance threshold.

In some examples, the information accuracy component 1250 is capable of, configured to, or operable to support a means for determining whether an accuracy of the available distance information satisfies an accuracy threshold, where the set of phase parameters is based on whether the accuracy satisfies the accuracy threshold.

In some examples, the information accuracy component 1250 is capable of, configured to, or operable to support a means for determining that the accuracy of the available distance information satisfies the accuracy threshold, where the set of phase parameters is based on a second link between the network entity and the RIS being served via beamfocusing in accordance with the available distance information.

In some examples, the information accuracy component 1250 is capable of, configured to, or operable to support a means for determining that the accuracy of the available distance information fails to satisfy the accuracy threshold, where the set of phase parameters is based on a second link between the network entity and the RIS being served via beamforming.

In some examples, the information accuracy component 1250 is capable of, configured to, or operable to support a means for determining a distance between the network entity and the RIS based on the available distance information, where the accuracy threshold is based on the determined distance.

In some examples, the information availability component 1230 is capable of, configured to, or operable to support a means for determining that the distance information is unavailable, where the focusing distance is based on the distance information being unavailable, and where the set of phase parameters is based on a first link between the RIS and the UE being served via beamfocusing in accordance with the focusing distance and a second link between the network entity and the RIS being served via beamforming.

In some examples, the focusing distance is based on one or more parameters associated with the RIS, one or more parameters associated with the communications from the network entity, or a geometry of an incident and reflected angle pair, or any combination thereof.

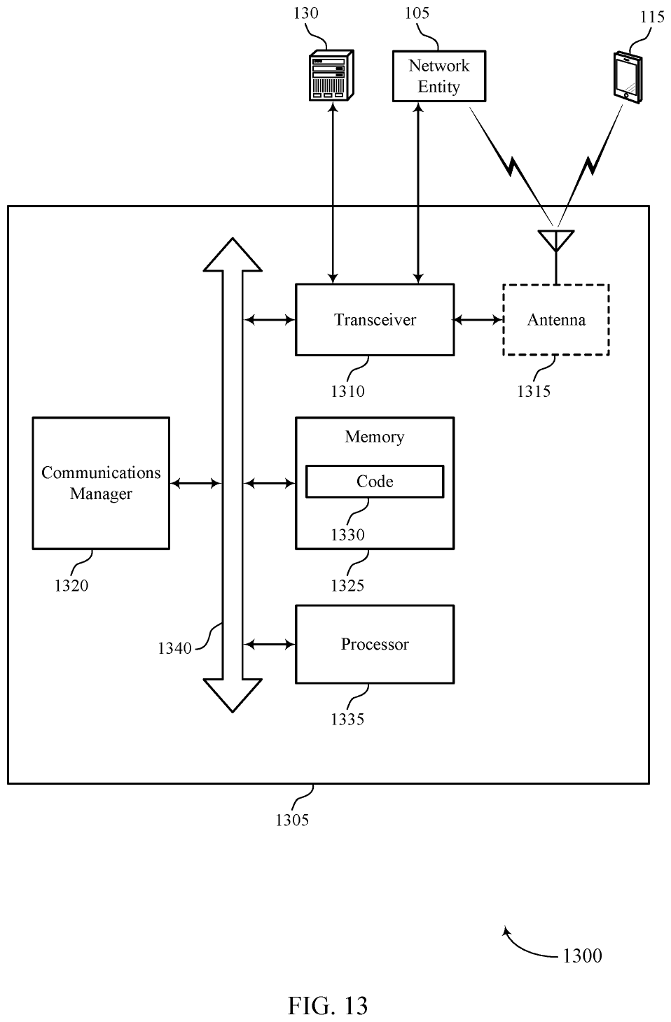

FIG. 13 shows a diagram of a system 1300 including a device 1305 that supports RIS operations with an unknown transmission distance in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least a memory 1325, code 1330, and at least a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, at least the processor 1335, or at least the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. At least the memory 1325 may store computer-readable, computer-executable code 1330 including instructions that, when executed by at least the processor 1335, cause the device 1305 to perform various functions described herein. The code 1330 may be stored in a non-transitory computer-readable medium such as system memory or another type of memory. In some cases, the code 1330 may not be directly executable by at least the processor 1335 but may cause a computer (e.g., when compiled and executed) to perform functions described herein. In some cases, at least the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate at least one memory array using a memory controller. In some other cases, a memory controller may be integrated into at least the processor 1335. The processor 1335 may be configured to execute computer-readable instructions stored in at least one memory (e.g., the memory 1325) to cause the device 1305 to perform various functions (e.g., functions or tasks supporting RIS operations with an unknown transmission distance). For example, the device 1305 or a component of the device 1305 may include at least a processor 1335 and memory 1325 coupled with at least the processor 1335, at least the processor 1335 and at least the memory 1325 may be configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within at least the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity (e.g., the device 1305) in accordance with examples as disclosed herein. For example, the communications manager 1320 is capable of, configured to, or operable to support a means for detecting a presence of a RIS for communicating with a UE. The communications manager 1320 is capable of, configured to, or operable to support a means for determining whether distance information between the network entity and the RIS is available. The communications manager 1320 is capable of, configured to, or operable to support a means for outputting control information associating with a set of phase parameters for the RIS, the set of phase parameters is usable by the RIS for reflecting communications from the network entity to the UE in accordance with a focusing distance that is based on the determined availability of the distance information. The communications manager 1320 is capable of, configured to, or operable to support a means for communicating a signal with the UE via the RIS in accordance with the set of phase parameters.

By including or configuring the communications manager 1320 in accordance with examples as described herein, the device 1305 may support techniques for improved communication reliability, reduced latency, improved user experience related to reduced processing, and more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by at least the processor 1335 to cause the device 1305 to perform various aspects of RIS operations with an unknown transmission distance as described herein, or the processor 1335 and the memory 1325 may be otherwise configured to perform or support such operations.

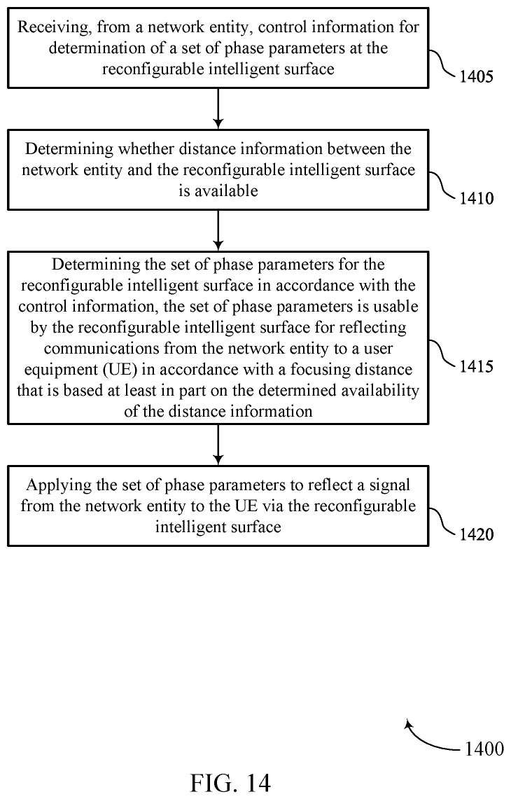

FIG. 14 shows a flowchart illustrating a method 1400 that supports RIS operations with an unknown transmission distance in accordance with aspects of the present disclosure. The operations of the method 1400 may be implemented by a RIS or its components as described herein. For example, the operations of the method 1400 may be performed by a RIS as described with reference to FIGS. 1 through 9. In some examples, a RIS may execute a set of instructions to control the functional elements of the RIS to perform the described functions. Additionally, or alternatively, the RIS may perform aspects of the described functions using special-purpose hardware.

At 1405, the method may include receiving, from a network entity, control information for determination of a set of phase parameters at the reconfigurable intelligent surface. The operations of block 1405 may be performed in accordance with examples as disclosed herein. In some examples, aspects of the operations of 1405 may be performed by a control information component 825 as described with reference to FIG. 8.

At 1410, the method may include determining whether distance information between the network entity and the reconfigurable intelligent surface is available. The operations of block 1410 may be performed in accordance with examples as disclosed herein. In some examples, aspects of the operations of 1410 may be performed by a distance information component 830 as described with reference to FIG. 8.

At 1415, the method may include determining the set of phase parameters for the reconfigurable intelligent surface in accordance with the control information, the set of phase parameters is usable by the reconfigurable intelligent surface for reflecting communications from the network entity to a user equipment (UE) in accordance with a focusing distance that is based at least in part on the determined availability of the distance information. The operations of block 1415 may be performed in accordance with examples as disclosed herein. In some examples, aspects of the operations of 1415 may be performed by a focusing distance component 835 as described with reference to FIG. 8.

At 1420, the method may include applying the set of phase parameters to reflect a signal from the network entity to the UE via the reconfigurable intelligent surface. The operations of block 1420 may be performed in accordance with examples as disclosed herein. In some examples, aspects of the operations of 1420 may be performed by a phase parameter component 840 as described with reference to FIG. 8.

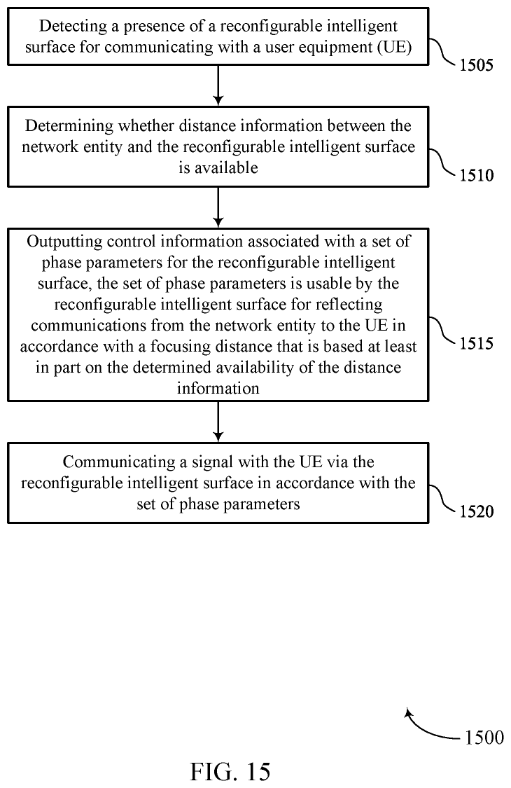

FIG. 15 shows a flowchart illustrating a method 1500 that supports RIS operations with an unknown transmission distance in accordance with aspects of the present disclosure. The operations of the method 1500 may be implemented by a network entity or its components as described herein. For example, the operations of the method 1500 may be performed by a network entity as described with reference to FIGS. 1 through 4 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include detecting a presence of a reconfigurable intelligent surface for communicating with a user equipment (UE). The operations of block 1505 may be performed in accordance with examples as disclosed herein. In some examples, aspects of the operations of 1505 may be performed by a RIS detection component 1225 as described with reference to FIG. 12.

At 1510, the method may include determining whether distance information between the network entity and the reconfigurable intelligent surface is available. The operations of block 1510 may be performed in accordance with examples as disclosed herein. In some examples, aspects of the operations of 1510 may be performed by an information availability component 1230 as described with reference to FIG. 12.

At 1515, the method may include outputting control information associated with a set of phase parameters for the reconfigurable intelligent surface, the set of phase parameters is usable by the reconfigurable intelligent surface for reflecting communications from the network entity to the UE in accordance with a focusing distance that is based at least in part on the determined availability of the distance information. The operations of block 1515 may be performed in accordance with examples as disclosed herein. In some examples, aspects of the operations of 1515 may be performed by a parameter information component 1235 as described with reference to FIG. 12.

At 1520, the method may include communicating a signal with the UE via the reconfigurable intelligent surface in accordance with the set of phase parameters. The operations of block 1520 may be performed in accordance with examples as disclosed herein. In some examples, aspects of the operations of 1520 may be performed by a signal component 1240 as described with reference to FIG. 12.

The following provides an overview of aspects of the present disclosure:

Aspect 1: A method for wireless communications at a RIS, comprising: receiving, from a network entity, control information for determination of a set of phase parameters at the RIS; determining whether distance information between the network entity and the RIS is available; determining the set of phase parameters for the RIS in accordance with the control information, the set of phase parameters is usable by the RIS for reflecting communications from the network entity to a UE in accordance with a focusing distance that is based at least in part on the determined availability of the distance information; and applying the set of phase parameters to reflect a signal from the network entity to the UE via the RIS.

Aspect 2: The method of aspect 1, wherein receiving the control information comprises: receiving an indication of the set of phase parameters.

Aspect 3: The method of aspect 1, wherein receiving the control information comprises: receiving an indication of an angular direction for determining of the set of phase parameters.

Aspect 4: The method of aspect 3, further comprising: receiving an indication of the distance information, wherein determining the set of phase parameters is based at least in part on the distance information.

Aspect 5: The method of any of aspects 1 through 4, wherein receiving the control information comprises: receiving DCI or an RRC message comprising the control information.

Aspect 6: The method of any of aspects 1 through 5, further comprising: determining that the distance information is available, wherein the focusing distance is based at least in part on the available distance information, and wherein the set of phase parameters is based at least in part on a first link between the RIS and the UE being served via beamfocusing in accordance with the focusing distance.

Aspect 7: The method of aspect 6, further comprising: determining a distance between the network entity and the RIS based at least in part on the available distance information, wherein the focusing distance is based at least in part on whether the distance satisfies a distance threshold.

Aspect 8: The method of any of aspects 6 through 7, further comprising: determining whether an accuracy of the available distance information satisfies an accuracy threshold, wherein the set of phase parameters is based at least in part on whether the accuracy satisfies the accuracy threshold.

Aspect 9: The method of aspect 8, further comprising: determining that the accuracy of the available distance information satisfies the accuracy threshold, wherein the set of phase parameters is based at least in part on a second link between the network entity and the RIS being served via beamfocusing in accordance with the available distance information.

Aspect 10: The method of aspect 8, further comprising: determining that the accuracy of the available distance information fails to satisfy the accuracy threshold, wherein the set of phase parameters is based at least in part on a second link between the network entity and the RIS being served via beamforming.

Aspect 11: The method of any of aspects 8 through 10, further comprising: determining a distance between the network entity and the RIS based at least in part on the available distance information, wherein the accuracy threshold is based at least in part on the determined distance.

Aspect 12: The method of any of aspects 1 through 3, and 5, further comprising: determining that the distance information is unavailable, wherein the focusing distance is based at least in part on the distance information being unavailable, and wherein the set of phase parameters is based at least in part on a first link between the RIS and the UE being served via beamfocusing in accordance with the focusing distance and a second link between the network entity and the RIS being served via beamforming.

Aspect 13: The method of any of aspects 1 through 12, wherein the focusing distance is based at least in part on one or more parameters associated with the RIS, one or more parameters associated with the communications from the network entity, or a geometry of an incident and reflected angle pair, or any combination thereof.

Aspect 14: A method for wireless communications at a network entity, comprising: detecting a presence of a RIS for communicating with a UE; determining whether distance information between the network entity and the RIS is available; outputting control information associated with a set of phase parameters for the RIS, the set of phase parameters is usable by the RIS for reflecting communications from the network entity to the UE in accordance with a focusing distance that is based at least in part on the determined availability of the distance information; and communicating a signal with the UE via the RIS in accordance with the set of phase parameters.

Aspect 15: The method of aspect 14, further comprising: determining the set of phase parameters for the RIS based at least in part on the determined availability of the distance information.

Aspect 16: The method of aspect 15, wherein outputting the control information comprises: outputting an indication of the determined set of phase parameters.

Aspect 17: The method of aspect 15, wherein outputting the control information comprises: outputting a first indication of an angular direction for determination of the set of phase parameters.

Aspect 18: The method of aspect 17, further comprising: determining that the distance information is available; and outputting a second indication of the available distance information for the determination of the set of phase parameters.

Aspect 19: The method of any of aspects 14 through 18, wherein outputting the control information comprises: outputting DCI or an RRC message comprising the control information.

Aspect 20: The method of any of aspects 14 through 19, further comprising: determining that the distance information is available, wherein the focusing distance is based at least in part on the available distance information, and wherein the set of phase parameters is based at least in part on a first link between the RIS and the UE being served via beamfocusing in accordance with the focusing distance.

Aspect 21: The method of aspect 20, further comprising: determining a distance between the network entity and the RIS based at least in part on the available distance information, wherein the focusing distance is based at least in part on whether the distance satisfies a distance threshold.

Aspect 22: The method of any of aspects 20 through 21, further comprising: determining whether an accuracy of the available distance information satisfies an accuracy threshold, wherein the set of phase parameters is based at least in part on whether the accuracy satisfies the accuracy threshold.

Aspect 23: The method of aspect 22, further comprising: determining that the accuracy of the available distance information satisfies the accuracy threshold, wherein the set of phase parameters is based at least in part on a second link between the network entity and the RIS being served via beamfocusing in accordance with the available distance information.

Aspect 24: The method of aspect 22, further comprising: determining that the accuracy of the available distance information fails to satisfy the accuracy threshold, wherein the set of phase parameters is based at least in part on a second link between the network entity and the RIS being served via beamforming.

Aspect 25: The method of any of aspects 22 through 24, further comprising: determining a distance between the network entity and the RIS based at least in part on the available distance information, wherein the accuracy threshold is based at least in part on the determined distance.

Aspect 26: The method of any of aspects 14 through 17, and 19, further comprising: determining that the distance information is unavailable, wherein the focusing distance is based at least in part on the distance information being unavailable, and wherein the set of phase parameters is based at least in part on a first link between the RIS and the UE being served via beamfocusing in accordance with the focusing distance and a second link between the network entity and the RIS being served via beamforming.

Aspect 27: The method of any of aspects 14 through 26, wherein the focusing distance is based at least in part on one or more parameters associated with the RIS, one or more parameters associated with the communications from the network entity, or a geometry of an incident and reflected angle pair, or any combination thereof.

Aspect 28: An apparatus for wireless communications at a RIS, comprising at least one processor; and at least one memory coupled with the at least one processor; wherein the at least one memory comprises instructions executable by the at least one processor to cause the apparatus to perform a method of any of aspects 1 through 13.

Aspect 29: An apparatus for wireless communications at a RIS, comprising at least one means for performing a method of any of aspects 1 through 13.

Aspect 30: A non-transitory computer-readable medium storing code for wireless communications at a RIS, wherein the code comprises instructions executable by at least one processor to perform a method of any of aspects 1 through 13.

Aspect 31: An apparatus for wireless communications at a network entity, comprising at least one processor; and at least one memory coupled with the at least one processor; wherein the at least one memory comprises instructions executable by the at least one processor to cause the apparatus to perform a method of any of aspects 14 through 27.

Aspect 32: An apparatus for wireless communications at a network entity, comprising at least one means for performing a method of any of aspects 14 through 27.

Aspect 33: A non-transitory computer-readable medium storing code for wireless communications at a network entity, wherein the code comprises instructions executable by at least one processor to perform a method of any of aspects 14 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. At least one processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by at least one processor, firmware, or any combination thereof. If implemented using software executed by at least one processor, the functions may be stored as or transmitted using one or more instructions or code of a computer-readable medium. Other examples and implementations are within the scope of the disclosure and appended claims. For example, due to the nature of software, functions described herein may be implemented using software executed by at least one processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the term “at least one” or the term “one or more” can include a single component performing multiple (e.g., all) listed steps, and can also include a combination of components, where each component performs a subset of the listed steps. In other words, as described herein, including in the claims, actions performed by “at least one” component should be construed as one or more components that, individually or collectively perform the actions.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a reconfigurable intelligent surface, comprising:
at least one processor; and
at least one memory coupled with the at least one processor, wherein the at least one memory comprises instructions executable by the at least one processor to cause the apparatus to:
receive, from a network entity, control information for determination of a set of phase parameters at the reconfigurable intelligent surface;
determine whether distance information between the network entity and the reconfigurable intelligent surface is available;
determine the set of phase parameters for the reconfigurable intelligent surface in accordance with the control information, the set of phase parameters is usable by the reconfigurable intelligent surface for reflecting communications from the network entity to a user equipment (UE) in accordance with a focusing distance that is based at least in part on the determined availability of the distance information; and
apply the set of phase parameters to reflect a signal from the network entity to the UE via the reconfigurable intelligent surface.

2. The apparatus of claim 1, wherein the instructions to receive the control information are executable by the at least one processor to cause the apparatus to:
receive an indication of the set of phase parameters.

3. The apparatus of claim 1, wherein the instructions to receive the control information are executable by the at least one processor to cause the apparatus to:
receive an indication of an angular direction for determining of the set of phase parameters.

4. The apparatus of claim 3, wherein the instructions are further executable by the at least one processor to cause the apparatus to:
receive an indication of the distance information, wherein determining the set of phase parameters is based at least in part on the distance information.

5. The apparatus of claim 1, wherein the instructions to receive the control information are executable by the at least one processor to cause the apparatus to:
receive downlink control information or a radio resource control message comprising the control information.

6. The apparatus of claim 1, wherein the instructions are further executable by the at least one processor to cause the apparatus to:
determine that the distance information is available, wherein the focusing distance is based at least in part on the available distance information, and wherein the set of phase parameters is based at least in part on a first link between the reconfigurable intelligent surface and the UE being served via beamfocusing in accordance with the focusing distance.

7. The apparatus of claim 6, wherein the instructions are further executable by the at least one processor to cause the apparatus to:
determine a distance between the network entity and the reconfigurable intelligent surface based at least in part on the available distance information, wherein the focusing distance is based at least in part on whether the distance satisfies a distance threshold.

8. The apparatus of claim 6, wherein the instructions are further executable by the at least one processor to cause the apparatus to:
determine whether an accuracy of the available distance information satisfies an accuracy threshold, wherein the set of phase parameters is based at least in part on whether the accuracy satisfies the accuracy threshold.

9. The apparatus of claim 8, wherein the instructions are further executable by the at least one processor to cause the apparatus to:
determine that the accuracy of the available distance information satisfies the accuracy threshold, wherein the set of phase parameters is based at least in part on a second link between the network entity and the reconfigurable intelligent surface being served via beamfocusing in accordance with the available distance information.

10. The apparatus of claim 8, wherein the instructions are further executable by the at least one processor to cause the apparatus to:
determine that the accuracy of the available distance information fails to satisfy the accuracy threshold, wherein the set of phase parameters is based at least in part on a second link between the network entity and the reconfigurable intelligent surface being served via beamforming.

11. The apparatus of claim 8, wherein the instructions are further executable by the at least one processor to cause the apparatus to:
determine a distance between the network entity and the reconfigurable intelligent surface based at least in part on the available distance information, wherein the accuracy threshold is based at least in part on the determined distance.

12. The apparatus of claim 1, wherein the instructions are further executable by the at least one processor to cause the apparatus to:
determine that the distance information is unavailable, wherein the focusing distance is based at least in part on the distance information being unavailable, and wherein the set of phase parameters is based at least in part on a first link between the reconfigurable intelligent surface and the UE being served via beamfocusing in accordance with the focusing distance and a second link between the network entity and the reconfigurable intelligent surface being served via beamforming.

13. The apparatus of claim 1, wherein the focusing distance is based at least in part on one or more parameters associated with the reconfigurable intelligent surface, one or more parameters associated with the communications from the network entity, or a geometry of an incident and reflected angle pair, or any combination thereof.

14. An apparatus for wireless communications at a network entity, comprising:
at least one processor; and
at least one memory coupled with the at least one processor, wherein the at least one memory comprises instructions executable by the at least one processor to cause the apparatus to:
detect a presence of a reconfigurable intelligent surface for communicating with a user equipment (UE);
determine whether distance information between the network entity and the reconfigurable intelligent surface is available;
output control information associated with a set of phase parameters for the reconfigurable intelligent surface, the set of phase parameters is usable by the reconfigurable intelligent surface for reflecting communications from the network entity to the UE in accordance with a focusing distance that is based at least in part on the determined availability of the distance information; and
communicate a signal with the UE via the reconfigurable intelligent surface in accordance with the set of phase parameters.

15. The apparatus of claim 14, wherein the instructions are further executable by the at least one processor to cause the apparatus to:
determine the set of phase parameters for the reconfigurable intelligent surface based at least in part on the determined availability of the distance information.

16. The apparatus of claim 15, wherein the instructions to output the control information are executable by the at least one processor to cause the apparatus to:
output an indication of the determined set of phase parameters.

17. The apparatus of claim 14, wherein the instructions to output the control information are executable by the at least one processor to cause the apparatus to:
output a first indication of an angular direction for determination of the set of phase parameters.

18. The apparatus of claim 17, wherein the instructions are further executable by the at least one processor to cause the apparatus to:
determine that the distance information is available; and
output a second indication of the available distance information for the determination of the set of phase parameters.

19. The apparatus of claim 14, wherein the instructions to output the control information are executable by the at least one processor to cause the apparatus to:
output downlink control information or a radio resource control message comprise the control information.

20. The apparatus of claim 14, wherein the instructions are further executable by the at least one processor to cause the apparatus to:
determine that the distance information is available, wherein the focusing distance is based at least in part on the available distance information, and wherein the set of phase parameters is based at least in part on a first link between the reconfigurable intelligent surface and the UE being served via beamfocusing in accordance with the focusing distance.

21. The apparatus of claim 20, wherein the instructions are further executable by the at least one processor to cause the apparatus to:
determine a distance between the network entity and the reconfigurable intelligent surface based at least in part on the available distance information, wherein the focusing distance is based at least in part on whether the distance satisfies a distance threshold.

22. The apparatus of claim 20, wherein the instructions are further executable by the at least one processor to cause the apparatus to:
determine whether an accuracy of the available distance information satisfies an accuracy threshold, wherein the set of phase parameters is based at least in part on whether the accuracy satisfies the accuracy threshold.

23. The apparatus of claim 22, wherein the instructions are further executable by the at least one processor to cause the apparatus to:
determine that the accuracy of the available distance information satisfies the accuracy threshold, wherein the set of phase parameters is based at least in part on a second link between the network entity and the reconfigurable intelligent surface being served via beamfocusing in accordance with the available distance information.

24. The apparatus of claim 22, wherein the instructions are further executable by the at least one processor to cause the apparatus to:
determine that the accuracy of the available distance information fails to satisfy the accuracy threshold, wherein the set of phase parameters is based at least in part on a second link between the network entity and the reconfigurable intelligent surface being served via beamforming.

25. The apparatus of claim 22, wherein the instructions are further executable by the at least one processor to cause the apparatus to:
determine a distance between the network entity and the reconfigurable intelligent surface based at least in part on the available distance information, wherein the accuracy threshold is based at least in part on the determined distance.

26. The apparatus of claim 14, wherein the instructions are further executable by the at least one processor to cause the apparatus to:
determine that the distance information is unavailable, wherein the focusing distance is based at least in part on the distance information being unavailable, and wherein the set of phase parameters is based at least in part on a first link between the reconfigurable intelligent surface and the UE being served via beamfocusing in accordance with the focusing distance and a second link between the network entity and the reconfigurable intelligent surface being served via beamforming.

27. The apparatus of claim 14, wherein the focusing distance is based at least in part on one or more parameters associated with the reconfigurable intelligent surface, one or more parameters associated with the communications from the network entity, or a geometry of an incident and reflected angle pair, or any combination thereof.

28. A method for wireless communications at a reconfigurable intelligent surface, comprising:
receiving, from a network entity, control information for determination of a set of phase parameters at the reconfigurable intelligent surface;
determining whether distance information between the network entity and the reconfigurable intelligent surface is available;
determining the set of phase parameters for the reconfigurable intelligent surface in accordance with the control information, the set of phase parameters is usable by the reconfigurable intelligent surface for reflecting communications from the network entity to a user equipment (UE) in accordance with a focusing distance that is based at least in part on the determined availability of the distance information; and
applying the set of phase parameters to reflect a signal from the network entity to the UE via the reconfigurable intelligent surface.

29. The method of claim 28, wherein receiving the control information comprises:
receiving an indication of the set of phase parameters.

30. A method for wireless communications at a network entity, comprising:
detecting a presence of a reconfigurable intelligent surface for communicating with a user equipment (UE);
determining whether distance information between the network entity and the reconfigurable intelligent surface is available;
outputting control information associated with a set of phase parameters for the reconfigurable intelligent surface, the set of phase parameters is usable by the reconfigurable intelligent surface for reflecting communications from the network entity to the UE in accordance with a focusing distance that is based at least in part on the determined availability of the distance information; and
communicating a signal with the UE via the reconfigurable intelligent surface in accordance with the set of phase parameters.
